(19) United States
(12) Patent Application Publication
(10) Pub. No.: US 2018/0023220 A1
(43) Pub. Date: Jan. 25, 2018

(54) METHOD FOR PRODUCING CARBON FIBER COMPOSITE MATERIAL

(71) Applicant: NATIONAL INSTITUTE OF ADVANCED INDUSTRIAL SCIENCE AND TECHNOLOGY, Tokyo (JP)

(72) Inventors: Kenji HATA, Tsukuba-shi (JP); Seisuke ATA, Tsukuba-shi (JP); Shigeki TOMONOH, Tsukuba-shi (JP); Howon YOON, Tsukuba-shi (JP)

(21) Appl. No.: 15/720,725

(22) Filed: Sep. 29, 2017

Related U.S. Application Data
(63) Continuation of application No. PCT/JP2016/060383, filed on Mar. 30, 2016.

(30) Foreign Application Priority Data
Mar. 31, 2015 (JP) 2015-074158

(51) Int. Cl. D01F 9/12; C01B 32/159; C01B 32/174

(52) U.S. Cl. CPC D01F 9/12; C01B 32/174; C01B 32/159; C08J 5/042

(57) ABSTRACT

Provided are a carbon fiber composite material and a producing method thereof comprising an adhesive layer having excellent conductivity and high peeling strength. A carbon fiber composite material according to the present application includes a first carbon fiber dispersion layer having carbon fibers dispersed in a thermosetting resin, a carbon nanotube dispersion layer having carbon nanotubes dispersed in a thermosetting resin, and a second carbon fiber dispersion layer having carbon fibers dispersed in a thermosetting resin, wherein the carbon nanotube dispersion layer is arranged between the first carbon fiber dispersion layer and the second carbon fiber dispersion layer, and the carbon nanotubes in the carbon nanotube dispersion layer are arranged in close contact with the carbon fibers of the first carbon fiber dispersion layer and the carbon fibers of the second carbon fiber dispersion layer.

### CROSS REFERENCE TO RELATED APPLICATIONS

This application is a continuation of International Application No. PCT/JP2016/060383, filed on Mar. 30, 2016, which claims priority to Japanese Patent Application No. 2015-074158, filed on Mar. 31, 2015. The entire disclosures of each of the above applications are incorporated herein by reference.

### FIELD

The present invention relates to a carbon fiber composite material and a method for producing the same. In particular, the present invention relates to a carbon fiber composite material comprising a reinforced fiber plastic and a producing method thereof.

### BACKGROUND

Fiber reinforced plastic (FRP) which is a composite of a reinforcing material such as glass fiber or carbon fiber and plastic which is a base material is used in a wide range of industrial fields such as automobiles, aircraft, and housing facilities as a light weight and high strength material. Carbon fiber reinforced plastic (CFRP) which uses a carbon fiber as a reinforced material has high durability and is a useful material having conductivity. A prepreg which is a FRP intermediate product is a sheet material in which a resin which is a base material is impregnated into a reinforcing material such as oriented glass fibers or carbon fibers, and is semi-cured by heating or drying. A prepreg is material that can be molded into any shape by adhering to a base material and solidifying.

In the case where a prepreg is adhered to base material or when prepregs are laminated together, since is necessary to interpose an adhesive layer, an adhesive layer having a large peeling strength is desired. In addition, since an adhesive layer which uses a resin as a material has low conductivity, even in the case when laminating prepregs including carbon fibers having conductivity, conductivity between prepreg layers is not obtained by an adhesive layer.

It is conceivable to add a material which imparts strength and conductivity to an adhesive layer as one method for solving the problems described above. For example, although it is conceivable to form the adhesive layer by mixing metal particles or carbon particles with a resin, since it is necessary to add a substantial amount of particles in order to obtain a sufficient conductivity, the properties of a lightweight prepreg may be lost. In addition, metal is chemically unstable and chemically stable gold or platinum are not suitable for use in a prepreg which requires a large area.

Carbon nanotubes (hereinafter, referred to as CNT) formed only of carbon atoms is an example of a lightweight and high strength material. CNT is a material having excellent electrical characteristics, thermal conductivity and mechanical properties. In order to form an adhesive layer by adding CNTs, a paste type composition obtained by mixing CNTs and a resin is required. However, when preparing a paste type composition containing CNTs, it is necessary to disperse CNTs which are present in a structure such as a large bundle due to CNT mutual cohesion (van der Waals force) in a resin. For example, Japanese Laid Open Patent Publication No. 2004-142972 proposes a method in which a CNT dispersion solution is prepared by unraveling a bundle of CNTs by kneading CNTs with an ionic liquid.

On the other hand, in the case of preparing a CNT dispersion liquid without using an ionic liquid, a method (A. L. M. Reddy et al. SCIENTIFIC REPORTS, 2,481 (2012)) of coating by spraying a dispersion liquid obtained by dispersing CNTs in a general-purpose organic solvent or a method of coating by an ink-jet method (Japanese Laid Open Patent Publication No. 2010-174084) are known. In the case of forming an adhesive layer containing CNTs, a process is necessary for removing the solution from the coated CNT dispersion liquid. As a result, in the case of using a dispersion liquid obtained by these known methods, the film thickness formed by one coating becomes thinner, for example, a long time for recoating is required for coating a thick film of 0.1 μm or more. In addition, the dispersion liquid obtained by these known methods has a low viscosity, is not suitable for coating, and an adhesive layer which has excellent flatness with a high film thickness is difficult to form at a high throughput.

For example, although typically a process is needed for thickly coating a CNT dispersion liquid onto a substrate up to about 1 mm in order to form an adhesive layer having a film thickness of 0.1 μm or more, preparation of a paste type composition having viscosity characteristics to allow such a process without using an ionic liquid was difficult. However, since an ionic liquid has a problem with chemical stability, sometimes the excellent properties of the CNTs are lost and thus it is not preferable for use in an adhesive layer for bonding a prepreg.

### SUMMARY

The present invention has been made to solve the problems of such conventional technology described above and to provide a carbon fiber composite material and a producing method thereof comprising an adhesive layer having excellent conductivity and high peeling strength.

According to one embodiment of the present invention, a carbon fiber composite material is provided including a first carbon fiber dispersion layer having carbon fibers dispersed in a thermosetting resin, a carbon nanotube dispersion layer having carbon nanotubes dispersed in a thermosetting resin, and a second carbon fiber dispersion layer having carbon fibers dispersed in a thermosetting resin, wherein the carbon nanotube dispersion layer is arranged between the first carbon fiber dispersion layer and the second carbon fiber dispersion layer, and the carbon nanotubes in the carbon nanotube dispersion layer are arranged in close contact with the carbon fibers of the first carbon fiber dispersion layer and the carbon fibers of the second carbon fiber dispersion layer.

In addition, a carbon fiber composite material is provided including a first carbon fiber dispersion layer having carbon fibers dispersed in a thermosetting resin, a carbon nanotube dispersion layer having carbon nanotubes dispersed in a thermosetting resin, and a second carbon fiber dispersion layer having carbon fibers dispersed in a thermosetting resin, wherein the carbon nanotube dispersion layer is arranged between the first carbon fiber dispersion layer and the second carbon fiber dispersion layer, and the carbon fiber composite material has at least one of an interlayer peeling strength of 300 J/m² or more, conductivity in a fiber axis direction of 0.1 S/cm or more, conductivity in a vertical direction with respect to the fiber axis direction of 10⁻⁵ S/cm or more, and a three-point bending strength of 500 MPa or more.

In the carbon fiber composite material, the carbon nanotube dispersion layer may be a film shape.

In the carbon fiber composite material, a size of a carbon nanotube aggregate within the carbon nanotube dispersion layer may be in a range of 5 μm or more and 50 μm or less of a median value of a particle size distribution at a volume standard.

In the carbon fiber composite material, a carbon nanotube density of the carbon nanotube aggregate within the carbon nanotube dispersion layer may be 0.1% by weight or more.

In the carbon fiber composite material, an average length of the carbon nanotube of the carbon nanotube aggregate within the carbon nanotube dispersion layer may be 1 μm or more.

In the carbon fiber composite material, a thickness of the carbon nanotube dispersion layer may be 0.1 μm or more.

In addition, according to one embodiment of the present invention, a producing method of a carbon fiber composite material is provided including forming a first carbon fiber dispersion layer by dispersing carbon fibers in a thermosetting resin, forming a carbon nanotube dispersion layer by dispersing carbon nanotubes in a thermosetting resin, and forming a second carbon fiber dispersion layer by dispersing carbon fibers in a thermosetting resin, wherein the carbon fiber composite material is formed by arranging the carbon nanotube dispersion layer between the first carbon fiber dispersion layer and the second carbon fiber dispersion layer, and the carbon nanotubes in the carbon nanotube dispersion layer are arranged in close contact with the carbon fibers of the first carbon fiber dispersion layer and the carbon fibers of the second carbon fiber dispersion layer.

In addition, according to one embodiment of the present invention, a producing method of a carbon fiber composite material is provided including forming a first carbon fiber dispersion layer by dispersing carbon fibers in a thermosetting resin, forming a carbon nanotube dispersion layer by dispersing carbon nanotubes in a thermosetting resin, and forming a second carbon fiber dispersion layer by dispersing carbon fibers in a thermosetting resin, wherein the carbon fiber composite material is formed by arranging the carbon nanotube dispersion layer between the first carbon fiber dispersion layer and the second carbon fiber dispersion layer, and the carbon fiber composite material has at least one of an interlayer peeling strength of 300 J/m² or more, conductivity in a fiber axis direction of 0.1 S/cm or more, conductivity in a vertical direction with respect to the fiber axis direction of 10⁻⁵ S/cm or more, and a three-point bending strength of 500 MPa or more.

In the producing method of a carbon fiber composite material the carbon nanotube dispersion layer may be a film shape.

In the producing method of a carbon fiber composite material, a size of a carbon nanotube aggregate within the carbon nanotube dispersion layer may be in a range of 5 μm or more and 50 μm or less of a median value of a particle size distribution at a volume standard.

In the producing method of a carbon fiber composite material, a carbon nanotube density of the carbon nanotube aggregate within the carbon nanotube dispersion layer may be 0.1% by weight or more.

In the producing method of a carbon fiber composite material, an average length of the carbon nanotube of the carbon nanotube aggregate within the carbon nanotube dispersion layer may be 1 μm or more.

In the producing method of a carbon fiber composite material, a thickness of the carbon nanotube dispersion layer may be 0.1 μm or more.

In addition, according to one embodiment of the present invention, a paste type carbon nanotube contained resin material coated on the first carbon fiber dispersion layer and/or the second carbon fiber dispersion layer of the carbon fiber composite material described above is provided, wherein the paste type carbon nanotube contained resin material may has a viscosity measured by a rheometer of 50 Pa·s or more in a stationary state and/or 20 Pa·s or less under a condition of a sheer rate of 100 s⁻¹ or more.

### BRIEF EXPLANATION OF THE DRAWINGS

FIG. 1A is a schematic diagram of a carbon fiber composite material 100 according to one embodiment of the present invention, and FIG. 1A shows a side view (or cross-section diagram) of the carbon fiber composite material 100 viewed from the oriented direction of carbon fibers 111;

FIG. 1B is a diagram exposing the interior of a CNT dispersion layer 130 by cutting away a portion;

FIG. 2A is a schematic diagram of a paste type composition 50 according to one embodiment of the present invention;

FIG. 2B is a schematic diagram of a paste type composition 50 according to one embodiment of the present invention;

FIG. 3A is a schematic diagram showing a moving method of an ultrasound generation tip according to one embodiment of the present invention when viewed from a beaker top surface;

FIG. 3B is a schematic diagram showing a moving method of an ultrasound generation tip viewed from the beaker side surface;

FIG. 4A shows an optical microscope image of only an epoxy resin of a comparative example, and shows a magnification of 100;

FIG. 4B shows a magnification of 1000;

FIG. 5A shows an optical microscope image of a paste type composition according to one embodiment of the present invention, and shows a magnification of 100;

FIG. 5B shows a magnification of 1000;

FIG. 6A shows an optical microscope image of a paste type composition according to one example of the present invention, and shows a magnification of 100;

FIG. 6B shows a magnification of 1000;

FIG. 7A shows an optical microscope image of a paste type composition according to one example of the present invention, and shows a magnification of 100;

FIG. 7B shows a magnification of 1000;

FIG. 8A shows a viscosity measurement result of a paste type composition according to one example of the present invention;

FIG. 8B shows a hysteresis of the paste type composition according to one example of the present invention;

FIG. 9 is a diagram showing a change in the passing of time of a CNT content amount and viscosity of the paste type composition according to one example of the present invention;

FIG. 10A is a diagram showing a paste type composition immediately after being placed on a PET substrate;

FIG. 10B is a diagram showing a paste type composition 1 minute after being placed on a PET substrate;

FIG. 11A shows the viscosity measurement results of a paste type composition according to one example of the present invention;

FIG. 11B shows an enlarged view of a region enclosed by the circle in FIG. 11A;

FIG. 12 is a diagram showing the size distribution of the paste type composition containing 0.1% by weight of CNTs according to one example of the present invention;

FIG. 13 is a diagram showing a particle size distribution by volume standard of the paste type composition according to one example of the present invention;

FIG. 14 is a diagram showing measurement results of interlayer peeling strength of a carbon fiber composite material using the paste type composition according to one example of the present invention;

FIG. 15 is a diagram showing measurement results of interlayer peeling strength of a carbon fiber composite material using the paste type composition according to one example of the present invention;

FIG. 16A is an optical microscope image of a broken surface of the carbon fiber composite material 100 according to one example of the present invention, and FIG. 16A shows a top surface view of the broken surface of the carbon fiber composite material 100;

FIG. 16B is a cross-sectional view of the broken surface of the carbon fiber composite material 100;

FIG. 17 is a diagram showing electrical conductivity of a carbon fiber composite material according to one example of the present invention;

FIG. 18A shows a storage modulus of a paste type composition according to one example of the present invention;

FIG. 18B shows a loss modulus of the paste-like composition according to one example of the present invention;

FIG. 19 is a diagram showing the evaluation results of adhesive strength of a carbon fiber composite material according to one example of the present invention;

FIG. 20 is a diagram showing electrical conductivity of the carbon fiber composite material according to one example of the present invention;

FIG. 21A shows an optical microscope image of the paste type composition according to one example of the present invention mixed with epoxy resin after dispersing the CNTs in acetone, and FIG. 21A shows a magnification of 300;

FIG. 21B shows a magnification of 1000;

FIG. 22A shows an optical microscope image of the paste type composition according to one example of the present invention mixed with epoxy resin after dispersing the CNTs in MIBK, and FIG. 22A shows a magnification of 300;

FIG. 22B shows a magnification of 1000;

FIG. 23 is a diagram showing the viscosity measurement results of the paste type composition according to one example of the present invention;

FIG. 24 is a diagram showing measurement results of interlayer peeling strength of the carbon fiber composite material according to one example of the present invention;

FIG. 25 is a diagram showing electrical conductivity of the carbon fiber composite material according to one example of the present invention;

FIG. 26A is a diagram showing a storage elastic modulus of the paste type composition according to one example of the present invention;

FIG. 26B is an optical microscope image at 100 magnification of a paste type composition obtained by dispersing CNTs in an epoxy resin by using a combination of a jet mill and ultrasonic dispersing machine;

FIG. 26C is an optical microscope image of a paste type composition obtained by dispersing CNTs in an epoxy resin by using a jet mill;

FIG. 27 is a diagram showing the evaluation results of adhesive strength of the carbon fiber composite material according to one example of the present invention;

FIG. 28 is a diagram showing electrical conductivity of the carbon fiber composite material according to one example of the present invention;

FIG. 29A shows an optical microscope image of a cross section of the carbon fiber composite material according to one example of the present invention, and FIG. 29A shows a reference example in which the paste type composition is not coated between carbon fiber dispersion layers;

FIG. 29B shows a reference example in which the paste type composition is not coated between carbon fiber dispersion layers;

FIG. 29C shows a comparative example in which only an epoxy resin was coated between the carbon fiber dispersion layers;

FIG. 29D shows a comparative example in which only an epoxy resin was coated between the carbon fiber dispersion layers;

FIG. 29E shows a carbon fiber composite material of example of the present invention;

FIG. 29F shows a carbon fiber composite material of example of the present invention;

FIG. 30A is a transmission electron microscope image of a cross-section of the carbon fiber composite material according to one example of the present invention;

FIG. 30B is a transmission electron microscope image of a cross-section of the carbon fiber composite material according to one example of the present invention;

FIG. 31A is a transmission electron microscope image of a cross-section of the carbon fiber composite material of a comparative example; and

FIG. 31B is a transmission electron microscope image of a cross-section of the carbon fiber composite material of a comparative example; and

FIG. 32A is a diagram showing a Raman Spectrum of a cross-section of the carbon fiber composite material according to one example of the present invention.

FIG. 32B is a diagram showing a Raman Spectrum of a cross-section of the carbon fiber composite material according to one example of the present invention.

11: CNT, 13: Fine Pore, 50: Paste Type Composition, 100: Carbon Fiber Composite Material, 110: First Carbon Fiber Dispersion Layer, 120: Second Carbon Fiber Dispersion Layer, 130: CNT Dispersion Layer, 131: CNT Aggregate, 133: Thermosetting Resin

### EMBODIMENTS

As a result of intensive studies to solve the problems described above by the present inventors, the development of a paste type composition was reached having a viscosity suitable for forming an adhesive layer with a high throughput by dispersing carbon nanotubes in a resin without using an ionic liquid. A carbon fiber composite material and a producing method thereof having high peeling strength and excellent conductivity is provided by applying and solidifying a paste type composition having a viscosity described in detail herein to a prepreg.

A carbon fiber composite material and a method of producing the same according to the present invention are explained below while referring to the drawings. Furthermore, the carbon fiber composite material and the method of producing the same of the present invention are not to be interpreted as being limited to the description of the embodiments and examples shown below. Furthermore, in the drawings referred to in the embodiments and in the examples described herein, the same reference numerals are attached to the same parts or parts having similar functions and repeated descriptions thereof will be omitted.

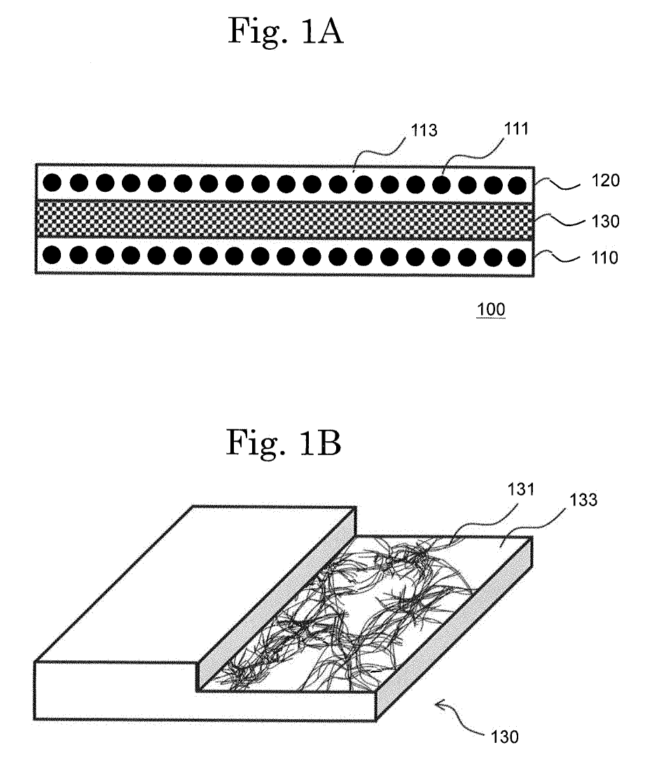

FIGS. 1A and 1B are schematic views of a carbon fiber composite material 100 according to one embodiment of the present invention. FIG. 1A is a side view (or cross section diagram) of the carbon fiber composite material 100 viewed from the direction of carbon fibers 111. FIG. 1B is a schematic view of a carbon nanotube dispersion layer (hereinafter, referred to as CNT dispersion layer) 130 which is an adhesive layer according to one embodiment of the present invention, a part of the CNT dispersion layer 130 is cut away to expose the interior. The carbon fiber composite material 100, for example, has a structure in which the CNT dispersion layer 130 is arranged between a first carbon fiber dispersion layer 110 and a second carbon fiber dispersion layer 120 which are sheet materials. Although a structure is shown in FIG. 1A in which the CNT dispersion layer 130 is arranged between two sheet materials, the present invention is not limited thereto. For example, a structure is possible in which the carbon fiber dispersion layer is arranged on a substrate via a CNT dispersion layer 130 using a desired substrate in place of one of the carbon fiber dispersion layers.

In the carbon fiber composite material 100 according to one embodiment of the present invention, carbon nanotubes within a carbon nanotube dispersion layer are arranged in close contact with the carbon fibers of the first carbon fiber dispersion layer and the carbon fibers of the second carbon fiber dispersion layer. Here, the carbon nanotubes within the carbon nanotube dispersion layer are arranged in close contact with the carbon fibers of the first carbon fiber dispersion layer and the carbon fibers of the second carbon fiber dispersion layer means that a distance between the carbon nanotubes and the carbon fibers of the first carbon fiber dispersion layer and the second carbon fiber dispersion layer is 500 nm or less and more preferably 100 nm or less.

### (Interlayer Peeling Strength)

The carbon fiber composite material 100 according to one embodiment of the present invention has an interlayer peeling strength (G1c) of 300 J/m² or more, preferably, 500 J/m² or more and more preferably 600 J/m² or more. Since it is generally known that carbon fiber composite materials arranged with such interlayer peeling strength have excellent impact properties, for example, they can be preferably applied to transportation equipment and the like.

### (Conductivity)

In the present specification, conductivity of the carbon fiber composite material 100 is measured by a two-terminal method by forming an electrode by coating a conductive paste to the end surfaces and upper and lower surfaces of the carbon fiber composite material 100 (both surfaces in the stacking direction of the carbon fiber composite material 100). The conductivity measured between an end surface and end surface of the carbon fiber composite material 100 is defined as conductivity in a fiber axis direction, and conductivity measured between the upper and lower surfaces of the carbon fiber composite material 100 is defined as vertical direction conductivity. The carbon fiber composite material 100 according to one embodiment of the present invention has conductivity in the fiber axis direction of 0.1 S/cm or more, preferably 1 S/cm or more and more preferably 10 S/cm or more. In addition, conductivity in a vertical direction is 10⁻⁵ S/cm or more, preferably 10⁻³ S/cm or more and more preferably 10⁻¹ S/cm or more. Since it is possible for carbon fiber composite materials arranged with such conductivity to safely diffuse a lightning current or act as a lighting arrestor for example, they are suitable for aircraft applications and automotive applications.

### (Three-Point Bending Strength)

The carbon fiber composite material 100 according to one embodiment of the present invention has a three-point bending strength of 500 MPa or more, preferably 750 MPa or more and more preferably 1000 MPa or more. A carbon fiber composite material arranged with such a three-point bending strength demonstrates the characteristic that it hardly deforms due to an external force, and is suitable in applications where deformation is undesirable such as when used in the exterior or casing of transportation equipment and the like.

The carbon fiber composite material 100 according to one embodiment of the present invention has at least one of the interlayer peeling strength, conductivity and three-point bending strength in the above described ranges. Therefore, the carbon fiber composite material 100 according to one embodiment of the present invention sometimes has two or all of the interlayer peeling strength, conductivity and three-point bending strength in the above described ranges.

### (Carbon Fiber Dispersion Layer)

In the present specification, a carbon fiber dispersion layer is a sheet-like member obtained by dispersing carbon fibers 111 into a thermosetting resin 113. In the present invention, the carbon fibers 111 are a known material having a desired tensile elastic modulus, tensile strength and tensile elongation and are not particularly limited. The carbon fibers 111 have, for example, a tensile elastic modulus of 260 G Pa or more and 440 GPa less, a tensile strength of 4.4 GPa or more and 6.5 GPa or less, and tensile elongation of 1.7% or more and 2.3% or less. In addition, the carbon fibers 111 may be arranged so that all of the fibers have the same orientation or may have a woven arrangement. It is possible to use a known thermosetting resin for the thermosetting resin 113, for example, selected from unsaturated polyester resins, vinyl ester resins, epoxy resins, benzoxazine resins, phenolic resins, urea resins, melamine resins and polyimide resins or a resin, these modified products and a mixture of two or more types. In addition, any thermosetting resin which is self-hardening by heating or contains a curing agent or curing accelerator may be used.

For example, it is possible to use a prepreg arranged with oriented carbon fibers as a reinforcement material in a thermosetting resin as the base material, and it is possible to form the first carbon fiber dispersion layer 110 and/or the second carbon fiber dispersion layer 120 by solidifying and heating the prepreg. Since a prepreg is sheet material in which a resin is semi-cured by heating or drying, it is possible to solidify into a desired shape together with the paste type composition after applying a paste type composition for forming a CNT dispersion layer and therefore is suitable considering workability.

### (Carbon Nanotube Dispersion Layer)

In one embodiment, a CNT dispersion layer 130 is a film shape. In addition, as shown in FIG. 1B, the CNT dispersion layer 130 is obtained by dispersing a carbon nanotube aggregate (hereinafter also referred to as CNT aggregate) 131 into a thermosetting resin 133 which is a base material. The CNT aggregate 131 has a discrete and reaggregate network structure in which a plurality of CNTs (or CNT bundle) and a plurality of CNT (or CNT bundle) are entangled. Adjacent CNT aggregates 131 further form a three-dimensional network structure. Therefore, a three-dimensional network structure which the CNT aggregate 131 includes is highly developed network of CNTs that has been spread around to a wide area, a continuous skeletal structure is formed in the CNT dispersion layer 130 in which the CNTs which form the CNT aggregate 131 are linked to provide a large peeling strength that has not been conventionally available in the CNT dispersion layer 130. In addition, by forming a continuous conductive path in the CNT dispersion layer 130 in which CNTs which form the CNT aggregate 131 are linked, it is possible to provide conductivity to the CNT dispersion layer 130. In the present specification, the CNT aggregate 131 is a region in which a CNT aggregate is observed using an optical microscope.

In addition, by arranging the CNT dispersion layer 130 with a region formed by the thermosetting resin 133, it is possible to provide physical properties which the thermosetting resin 133 has to the CNT dispersion layer 130. In the CNT dispersion layer 130, if the CNT aggregate 131 which encloses the thermosetting resin 133 is arranged, the CNT aggregate 131 is arranged to have a bubble film, it become easier to form a skeletal structure and/or conductive path in which the CNT aggregate 131 is continuous which is suitable for obtaining the effects of the present invention.

### (Carbon Nanotube)

The CNT aggregate 131 according to the present invention has a network structure in which points in which a CNT intersect with a plurality of CNTs are linked by a van der Waals force. As a result, the average length of a CNT is preferably 1 μm or more, more preferably 5 μm or more, and yet more preferably 10 μm or more. Since such a long CNT has many joining points between CNTs, it is possible to form a network structure with excellent shape retention properties. Furthermore, the CNT aggregate according to the present invention may contain such long CNTs and the producing method thereof is not particularly limited. The average length of a CNT means an average value obtained by measuring the length of any of 10 CNTs or more by observing a CNT placed on a silicon wafer by an atomic force microscope (AFM).

### (Thermosetting Resin)

In the present invention, the thermosetting resin 133 is selected from one or more types of silicone resins, modified silicone resins, acrylic resins, chloroprene resins, polysulfide resins, polyurethane resins, polyisobutyl based resins, fluorosilicone resins or selected from a mixture of two or more of these.

### (Paste Type Composition)

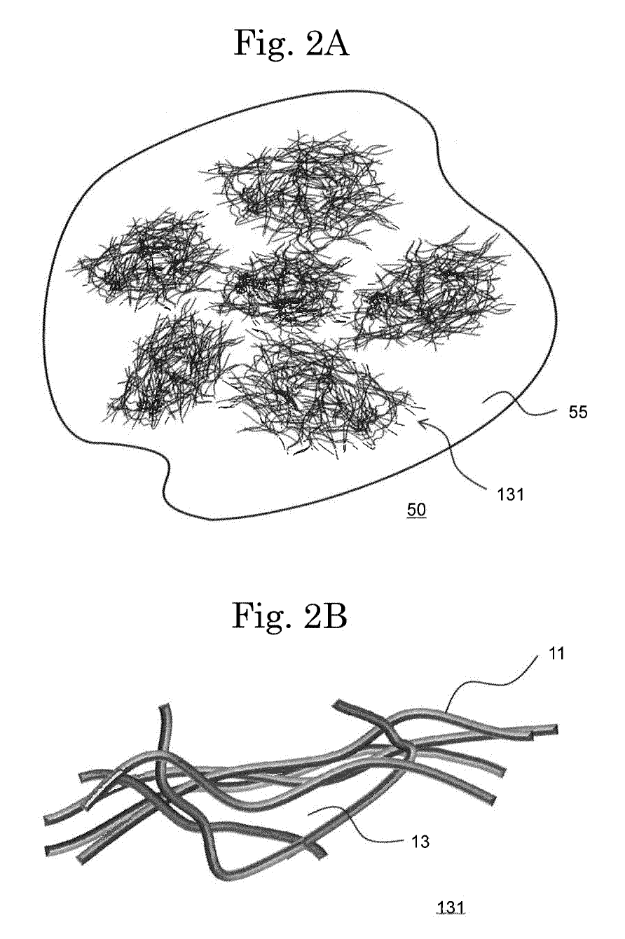

The CNT dispersion layer 130 according to the present invention is formed by solidifying a paste type composition. FIGS. 2A and 2B are schematic diagrams of a paste type composition 50 according to one embodiment of the present invention. The paste type composition 50 according to the present invention includes a CNT aggregate 131 and a monomer solution containing a solution having an ion strength of 1.0 mol/L or less, and viscosity measured by a rheometer becomes 50 Pa·s or more under the condition of a stationary state, and 20 Pa·s or less under a condition of a shear rate of 100 s⁻¹ or more.

As is shown in FIG. 2A, the paste type composition 50 according to the present invention is in a state in which a plurality of CNT aggregates 131 is included together with the monomer solution 55. In addition, as is shown in FIG. 2B, the CNT aggregate 131 has a network structure in which a plurality of CNTs 11 (or CNT bundle) spreads in a three-dimensional space, and have many fine pores 13 therein. Such a network structure is formed by points joining due to van der Waals forces when CNTs 11 (or CNT bundle) intersect with a plurality of CNTs 11 (or CNT bundles). A CNT aggregate 131 in a stationary state can maintain a network structure having fine pores 13 by the van der Waals force described above, and the monomer solution 55 which forms the paste type composition 50 according to the present invention can be incorporated within the fine pores 13.

Furthermore, the paste type composition 50 has a structure in which a plurality of CNT aggregates 131 are respectively adjacent. However, since coupling between CNT aggregates 131 is weak, after diluting the paste type composition 50 with the same solution as the solution contained in the monomer solution 55 which forms the paste composition 50, it is possible to obtain a structure in which a single CNT aggregate 131 is dispersed in the solution by stirring well using a magnetic stirrer and the like. By utilizing this, the size of the CNT aggregate 131 can be measured by a laser diffraction method or by microscope observation.

As described above, coupling between CNTs in the CNT aggregate 131 is mainly due to the Van der Waals force at the intersection point between the CNTs. In Japanese Laid Open Patent Publication No. 2004-142972, a bond between CNTs is formed by “cationic −π” interaction through an ionic liquid to obtain a CNT three-dimensional network structure. On the other hand, in the CNT aggregate 131 according to the present invention, it was found that it is possible to obtain a CNT aggregate 131 having a three-dimensional network structure by using only a direct bond by the Van der Waals force between CNTs at the intersection between the CNTs. By forming the CNT aggregate 131 using a direct bond between CNTs, it is possible to obtain the paste type composition 50 of the present invention formed from the CNT aggregate 131 with excellent shape retention properties.

The paste type composition 50 according to the present invention having the structure described above meets the following conditions for forming a flat CNT dispersion layer 130 having a high thickness that includes a CNT with a high throughput by using a coating method such as bar coating. That is, (1) since the paste type composition 50 according to the present invention has a high shape retention property in the stationary state, it is possible to arrange it higher on the substrate. (2) In addition, since the paste type composition 50 shows fluidity when applying a shearing stress, it is possible to be spread wet on a carbon fiber dispersion-layer using a coating method such as bar coating, and it is possible to form a flat and uniform CNT dispersion layer 130. (3) Furthermore, since the shape retaining property of the paste type composition 50 in a stationary state is instantly recovered when releasing shear stress, it is possible to maintain the shape of the thick film without dripping or the like immediately after the formation of the flat thick film using a coating method such as bar coating.

The CNT aggregate 131 in a stationary state can maintain a network structure having fine pores 13 due to coupling between CNTs and it is possible to incorporate the monomer solution 55 which forms the paste type composition 50 according to the present invention into the interior of a fine pore 13. As a result, the paste type composition 50 according to the present invention has low fluidity in the stationary state, and the paste type composition 50 according to the present invention has a shape retaining property. If the shape retaining property in such a stationary state is utilized, by using a coating method such as bar coating after arranging the paste type composition 50 high on the carbon fiber dispersion layer, it is possible to form the CNT dispersion layer 130 including thick CNTs at a high throughput. Here, as a shape retaining property shown by the paste type composition 50 according to the present invention, after the paste type composition 0.2 g is placed in a shape having a height of 5 mm height or more on a glass plate, it is preferred that the height after 1 minute becomes 2 mm or more, more preferably 3 mm or more, more preferably 4 mm or more and even more preferably 5 mm or more.

Furthermore, the shape retaining property shown by the paste type composition 50 according to the present invention is correlated with the value of viscosity measured at a low shear rates condition. In the present specification, the viscosity with the paste type composition 50 according to the present invention is measured by a rheometer under the following conditions. A viscosity is used obtained by measuring the torque applied to the circular flat plate 20 seconds or more after rotating the circular plate after placing the paste type composition between a measurement stage and a round flat plate having diameter of 40 mm or less and having an interval of 500 μm or more, the temperature of the paste type composition when measured is assumed to be in the range of 15° C. to 25° C. The viscosity of the paste type composition 50 according to the present invention measured by a rheometer at a low shear rate of 0.1 s⁻¹ or less under the conditions described above is preferably 50 Pa·s or more, more preferably 100 Pa·s or more, even more preferably 200 Pa·s or more, even more preferably 500 Pa·s or more and still more preferably 1000 Pa·s or more.

On the other hand, when shear stress is added, the paste type composition 50 of the present invention also includes the feature of high fluidity when shear stress is applied. This is because when shear stress is added to a network structure in the CNT aggregate 131, while maintaining an intersection point between CNTs, the fine pores 13 are compressed, and the monomer solution 55 present in the interior of the fines pores 13 bleeds to the exterior. If the fluidity shown by this shear stress is utilized, when shear stress is added by various coating methods such as blade coating, the paste type composition 50 of the present invention can be wet-spread on a carbon fiber dispersion layer. In this way, it is possible to form a uniform and flat CNT dispersion layer 130.

In the present specification, the fluidity shown by the paste type composition 50 is defined as the value of viscosity measured in a high shear rate region measured by a rheometer. That is, under the high shear conditions where viscosity to be measured by a rheometer is 100 s⁻¹ or more, the value of viscosity of the paste type composition 50 according to the present invention is preferably 20 Pa·s or less, more preferably 10 Pa·s or less, even more preferably less 5 Pa·s, even more preferably less 2 Pa·s, and even further preferably 1 Pa·s or less.

Therefore, the paste type composition 50 of the present invention shows a shape retaining property in a stationary state, and preferably shows fluidity when a shear stress is applied, and is preferred that viscosity under a low shear rate condition of 0.1 s⁻¹ or less is a value of 50 Pa·s or more and the viscosity under a high shear rate of 100 s⁻¹ or more is a value of 10 Pa·s or less. More preferably, the viscosity at a shear rate of 0.1 s⁻¹ is a value 100 times or more of the viscosity at a shear rate of 100 s⁻¹.

In addition, when the paste type composition 50 of the present invention is released from the shear stress, it has the feature of recovering the shape retaining property in a short time. Such a recovery property of shape and the retaining property are important for maintaining the shape of the CNT dispersion layer 130 formed from the paste type composition 50 of the present invention which is formed by various coating methods such as blade coating, and it is possible to avoid the so-called dripping problem. In this way, by subjecting the paste type composition 50 having a maintained shape to a drying process and the like, it is possible to obtain the uniform and flat CNT dispersion layer 130 containing CNTs. In the present specification, the recovery property of the shape retaining property in the paste type composition 50 described above is measured in the following way by using a rheometer capable of changing the shear rate from 100 s⁻¹ or more to 0.1 s⁻¹ or less within 0.01 seconds and performing the viscosity measurement within an interval of 0.01 seconds or less. The paste type composition 50 is placed between a measurement stage and a circular plate with a diameter of 40 mm or less and having an interval of 500 μm or more. After rotating the circular flat plate at a shear rate of 100 s⁻¹ or more for 20 seconds or more, the shear rate is changed up to 0.1 s⁻¹ or less within 0.01 seconds. Around this time, viscosity obtained by measuring the torque applied to the circular plate is used. The temperature of the paste type composition 50 at the time of measurement is assumed to be in the range of 15° C. to 25° C. The paste type composition 50 according to the present invention has a viscosity measured around a change in the shear rate from 100 s⁻¹ or more to 0.1 s⁻¹ or less preferably rises from a value of 20 Pa·s or less to a value of 40 Pa·s or more within 0.1 seconds, more preferably rises from a value of 10 Pa·s or less to a value of 40 Pa·s or more, more preferably rises from a value of 10 Pa·s or less to a value of 100 Pa·s or more, more preferably rises from a value of 5 Pa·s or less to a value of 100 Pa·s or more, more preferably rises from a value of 5 Pa·s or less to a value of 150 Pa·s or more, and more preferably rises from a value of 5 Pa·s or less to a value of 200 Pa·s or more.

The size of the CNT aggregate 131 included in the paste type composition 50 of the present invention is preferred to be not too coarse in terms of forming a flat and uniform CNT dispersion layer 130. Furthermore, since it is necessary to hold the monomer solution 55 in the interior of the fine pores 13, the CNT aggregate 131 is preferably present at a high density in a range where entanglement is possible between CNTs. Consequently, the CNT aggregate 131 is required to have a size to a certain degree or larger. In the present specification, the size of the CNT aggregate 131 containing fine pores 13 is defined as follows. The paste type composition 50 containing the CNT aggregate 131 is diluted to a volume of 100 times or more using the same solution as the solution included in the monomer solution 55 which forms the paste type composition 50. A structure s obtained in which a single CNT aggregate 131 is dispersed in a solution by stirring for 1 hour or more using only a magnetic stirrer. The size distribution of the single dispersed CNT aggregate 131 is measured by a laser diffraction method or microscopic observation. When image analysis is used, a circular area-corresponding diameter obtained from the area projected on the image is used as the size of the CNT aggregate 131. The size of the CNT aggregate 131 can be evaluated by the median of the size distribution by a volume standard obtained by the method described above. Specifically, the CNT aggregate 131 according to the present invention preferably has a median value in a particle size distribution at a volume standard of 5 μm or more and 50 μm or less, more preferably 10 μm or more and 40 μm or less, and even more preferably 30 μm or less.

The concentration of the CNT aggregate 131 present within the paste type composition 50 according to the present invention is preferably 0.1% by weight or more, more preferably 0.3% by weight or more. By increasing the concentration of the CNT aggregate 131, it is possible to hold more of the monomer solution 55 in the interior of the fine pores 13 of the CNT aggregate 131, and obtain the paste type composition 50 having the excellent shape retaining property.

### (Monomer Solution)

The monomer solution 55 contained in the paste type composition 50 according to the present invention is a mixture solution of a monomer becoming the thermosetting resin 133 by polymerization and a solution capable of dissolving the monomer. In addition, the monomer solution 55 may be obtained by blending a curing agent and curing accelerator according to necessity.

### (Solution)

As described above, since an ionic liquid has a problem in chemical stability, the excellent properties of the CNTs may be impaired which is not preferable for the paste type composition 50 according to the present invention. Therefore, a solution forming the paste type composition 50 according to the present invention is preferred to have a low ionic strength. In the paste type composition 50 according to the present invention, CNTs are bonded at points by the Van der Waals force produced by entanglement between CNTs, and which is thought to express the shape retaining property of a three-dimensional network structure. When an ionic liquid with a high ionic strength is used, the distance between CNTs is separated (loosened) due to affinity of ions between the CNTs, and the Van der Waals force weakens.

Ionic strength is defined by the following formula (1).

$$I = \frac{1}{2} {\sum }_{i }^{ } {m}_{i} {z}_{i}^{2} \qquad ( 1 )$$

Here, m is a molar concentration of each ion and z indicates a charge.

In the paste type composition 50 according to the present invention, the ionic strength of a solution is preferably 1.0 mol/L or less, more preferably 0.5 mol/L or less. If the ionic strength described above is satisfied, the solution included in the paste type composition 50 according to the present invention may be a liquid in which a liquid substance such as an organic solvent or water and a dispersant or a polymer compound or the like is dissolved. As an organic solvent used in the solution according to the present invention, for example, isobutyl alcohol, 2-propanol, N,N-dimethylformamide, styrene, 1-butanol, 2-butanol, ethanol, methanol, n-methylpyrrolidone, methyl isobutyl ketone, methyl ethyl ketone, ethylene glycol, ethyl acetate, cyclohexanol, tetrahydrofuran or the like can be used. As the dispersant used in the solution according to the present invention, for example, cholic acid, sodium cholate, sodium dodecyl sulfate, stearyl stearate, diglycerin oleate, citric acid fatty acid monoglyceride, sodium polyacrylate, polyvinyl alcohol and the like can be used. In addition, as a solution according to the present invention, a solution in which a polymer compound or a monomer thereof can be used and, for example, as the polymer compound polyethylene, polyvinyl chloride, polystyrene, polytetrafluoroethylene, dimethylpolysiloxane, polyurethane, polyphenol, polyethylene terephthalate or the like can be used.

### (Properties of Carbon Nanotube Dispersion Layer)

It is possible to form the CNT dispersion layer 130 according to the present invention using the paste type composition 50 according to the present invention described above. The CNT dispersion layer 130 according to the present invention is formed by coating or printing the paste type composition 50 according to the present invention on the first carbon fiber dispersion layer 110 and/or the second carbon fiber dispersion layer 120. The CNT dispersion layer 130 according to the present invention is preferred to have a thickness of 0.1 μm or more, flatness of 30% or less, and CNT purity of 90% or more.

Furthermore, in the present specification, “flatness” of the CNT dispersion layer 130 is defined as follows. In any 10 or more locations each separated by 1 mm respectively in a CNT dispersion layer 130, the thickness is measured by a laser type displacement gauge, and a value obtained by dividing the standard deviation Ra of the measured value thereof by an average value t is expressed as flatness

In the conventional technology, in order to form a thick CNT dispersion layer such as the CNT dispersion layer 130 according to the present invention, in addition to taking a long time, it was difficult to secure a sufficient flatness due to recoating. By using the paste type composition 50 according to the present invention, it is possible to form a thick CNT dispersion layer 130 with high flatness and with a high throughput.

### (Method of Producing Paste Type Composition)

A method for producing the paste type composition 50 according to the present invention described above is not particularly limited as long as a paste type composition is obtained which satisfies the conditions as defined in the present specification. However, in order to obtain a paste type composition according to the present invention, it is preferable to form a network structure coupling CNT with as many CNTs as possible contained in a CNT aggregate. In order to obtain such a network structure, a dispersion method is necessary to reasonably unravel a bundle of CNTs which is a raw material and keep the length of the CNTs. Furthermore, in order to obtain a paste type composition according to the present invention with very high viscosity in a stationary state, it is necessary to run on uniform dispersion in a medium with high viscosity.

A general dispersion process of CNTs is classified into three. 1. A method for mechanically applying a shear force (ball mill, roller mill, vibration mill, kneader, etc.), 2. A method using cavitation (ultrasonic dispersion), 3. A method using a turbulent flow (jet mill, nanomizer etc.). Among these, it is difficult to overcome the Van der Waals force and unravel the entanglement between CNTs just by a method classified into a method for mechanically applying a shearing force. Although a gel composition is obtained just by a shear force in Japanese Laid Open Patent Publication No. 2004-142972 which weakens the binding itself by the Van der Waals force between CNTs by using an ionic liquid as a solvent, a different dispersion method is necessary in the present invention which uses the Van der Waals force between CNTs to form a network structure.

On the other hand, in the method using cavitation, although the Van der Waals force is overcome and the effects of unraveling the bonds between CNTs is high, there is a problem of attenuation of ultrasound at short distance in a medium with high viscosity such as the paste type composition according to the present invention. Therefore, although dispersion proceeds in CNTs in the close vicinity of a probe in the conventional technology, dispersion does not proceed with respect to a CNT which is once flicked to a far distance from a probe, and because it is difficult for the CNT described above to return again to the vicinity of the probe due to the shape retaining property of the paste type composition according to the invention, sufficiently uniform dispersion in which the bonds between CNTs are unraveled is not obtained as a result.

Thus, in one embodiment of the present invention, an ultrasonic generator probe is moved in a container containing the dispersion liquid. Furthermore, by setting the movement path of the probe so that the movement of the probe reaches throughout the container, it is possible to make dispersion proceed for all CNTs in the container and realize a more uniform dispersion.

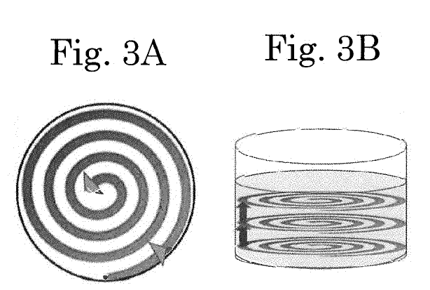

In one embodiment of the present invention, as is shown in FIGS. 3A and 3B, after introducing a solution as well as carbon nanotubes into a fixed cylindrical beaker, and irradiating ultrasonic waves to the solution while moving the ultrasound probe in a spiral shape, it is possible to make dispersion proceed for CNTs located throughout the container and realize a more uniform dispersion.

In addition, in the present invention, it is possible to disperse CNTs in a solution by separately using a number of different dispersion techniques in a stepwise manner. That is, after a usual dispersion process to obtain a dispersion liquid with low viscosity by stirring or the like, any of the dispersion methods described above can be applied after a rise in viscosity and drop in fluidity. In addition, any two or more dispersion methods described above may be used in combination after a rise in viscosity and drop in fluidity. For example, the method using cavitation and the method using turbulence may be combined. The CNT dispersion layer 130 according to the present invention can be formed by dispersing carbon nanotubes in a thermosetting resin and solidifying.

### (Synthesis Method of CNT)

A synthesis method of CNTs used to produce the paste type composition according to the present invention is not particularly limited as long as the characteristics of the CNT defined in the present specification are provided. However, as described above, since it is necessary to synthesize long CNTs of 1 μm or more, for example, production can be performed using the methods described in International Patent Publication WO2006/011655 by the inventors of the present invention.

### (Producing Method of Carbon Fiber Dispersion Layer)

A carbon fiber dispersion layer according to the present invention can be formed by dispersing carbon fibers in a thermosetting resin and solidifying.

### (Producing Method of Carbon Fiber Composite Material)

It is possible to obtain a carbon fiber composite material 100 interposed with the CNT dispersion layer 130 by coating or printing the paste type composition 50 according to the present invention prepared in this way on the first carbon fiber dispersion layer 110 and solidifying. After coating or printing the paste type composition 50, the solution contained in the paste type composition 50 is removed by drying or washing to obtain the CNT dispersion layer 130. In addition, since the first carbon fiber dispersion layer 110 is an intermediate product in which the impregnated thermosetting resin is semi-solidified, it is solidified with the CNT dispersion layer 130 by heating. The heating temperature can be set based on the temperature at which the thermosetting resin contained in the paste type composition 50 solidifies, and based on the temperature at which the thermosetting resin 113 impregnated in the carbon fiber dispersion layer 110 solidifies. Therefore, in the present invention, it is preferred to select each thermosetting resin so that a difference between the temperature at which the thermosetting resin contained in the paste type composition 50 solidifies, and the temperature at which the thermosetting resin 113 impregnated in the carbon fiber dispersion layer 110 solidifies is reduced. In particular, it is preferable that the thermosetting resin contained in the paste type composition 50 and the thermosetting resin 113 impregnated in the carbon fiber dispersion layer 110 are the same type of thermosetting resin, because the interface between the first carbon fiber dispersion layer 110 and the CNT dispersion layer 130 fuses during solidification and peeling strength is increased. In this way, by using the paste type composition 50 according to the present invention, it is possible to produce a thick CNT dispersion layer 130 having excellent evenness. The CNT dispersion layer 130 according to the present invention produced in this way has a thickness of 0.1 μm or more, flatness of 30% or less and CNT purity of 90% or more.

As described above, according to the present invention, by using a paste type composition including CNTs having an appropriate viscosity and high shape retaining property at the time of coating, it is possible to produce a carbon fiber composite material having an excellent conductivity with thickness of 0.1 μm or more and high peeling strength.

### Example

### (Paste Type Composition)

A paste type composition of the Example was prepared using the CNT produced by the method described in International Patent Publication WO2006/011655 and an epoxy resin (Epikote 806, Mitsubishi Chemical). Furthermore, the epoxy resin used has a viscosity of 15 to 25 Pa·s, epoxy equivalent of 160 to 170, appearance: liquid at normal temperature and specific gravity of 1.2 g/cm³. A jet mill (Jokoh Corp., Nano jet Pal (registered trademark) JN10) incorporating a pump for feeding at high pressure and high viscosity was used in the preparation of the paste composition. As an example, 0.1% by weight, 0.2% by weight and 0.5% by weight of CNTs was added, passed through a flow path with a diameter of 200 μm and processing pressure of 60 MPa 6 times (4 times at 0.5% by weight) and the CNTs were dispersed in the epoxy resin. In this way, a paste type composition of the Example was obtained.

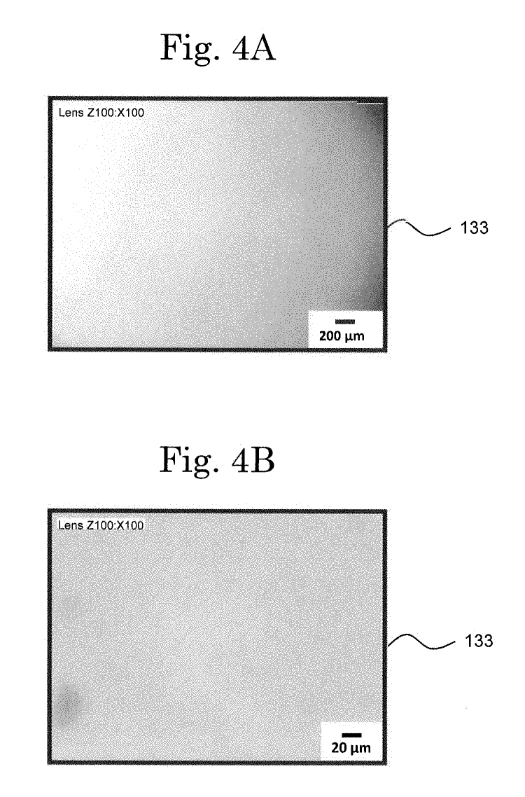

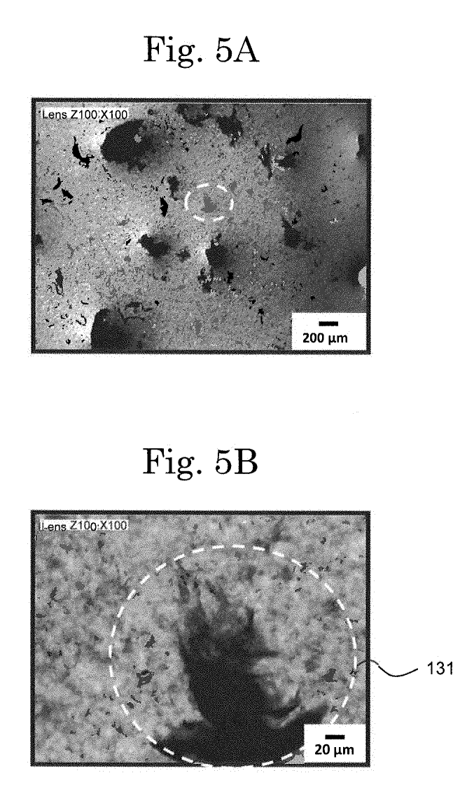

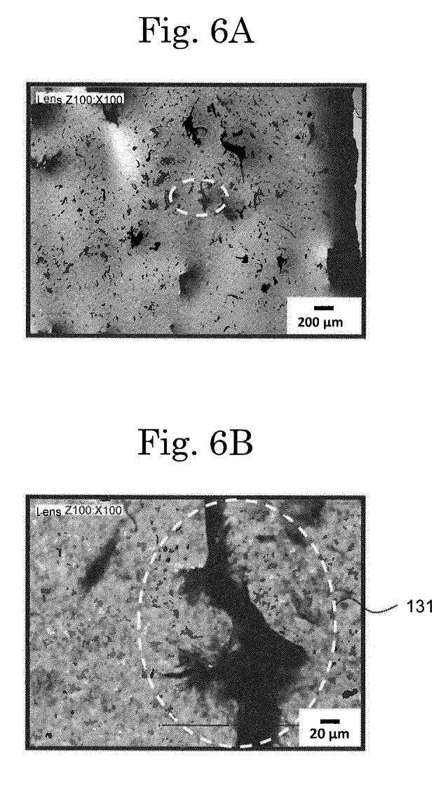

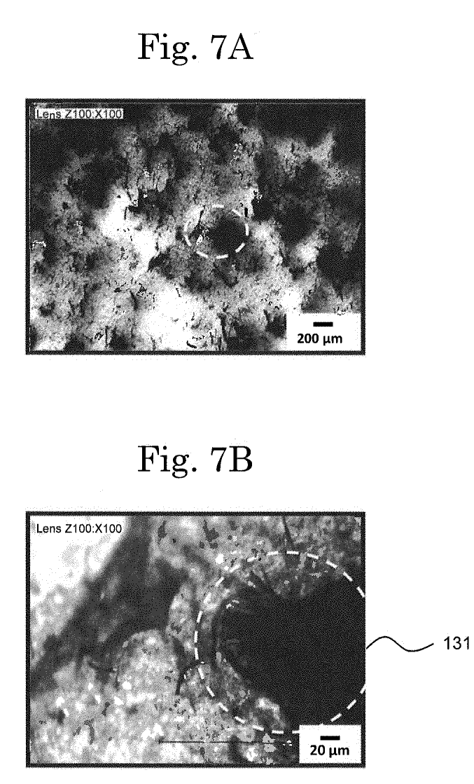

In order to confirm the dispersion state of CNTs, polyimide tape was attached to both end sides of the upper surface of a slide glass, and a paste type composition of the Example obtained was stretched and coated to a thickness of 70 μm at the center part of the glass slide using a glass rod. Only an epoxy resin was applied as a Comparative Example. The paste type composition was observed using an optical microscope (Digital Microscope VHX-1000, KEYENCE). FIGS. 4A and 4B show optical microscope images of only the epoxy resin of the Comparative Example, FIG. 4A is at a magnification of 100, FIG. 4B is at a magnification of 1000. FIGS. 5A and 5B show optical microscopic images of the paste type composition of the Example dispersed with 0.1% by weight of CNTs, FIG. 5A is at a magnification of 100, FIG. 5B is at a magnification of 1000. FIGS. 6A and 6B show optical microscopic images of the paste type composition of the Example dispersed with 0.2% by weight of CNTs, FIG. 6A is at a magnification of 100, FIG. 6B is at a magnification of 1000. FIGS. 7A and 7B show optical microscope images of the paste type composition of the Example dispersed with 0.5% by weight of CNTs, FIG. 7A is at a magnification of 100, FIG. 7B is at a magnification of 1000. From these results, in the paste type composition of the Example, it was clear that CNTs were highly dispersed in the epoxy resin.

### (CNT Content and Viscosity of Paste Type Composition)

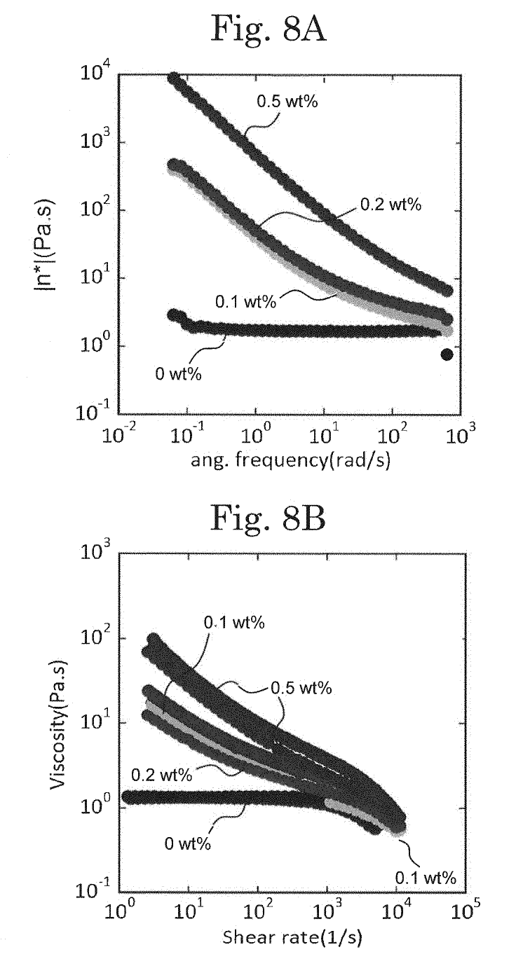

Viscosity of the paste type composition of the Example containing 0.1% by weight, 0.2% by weight or 0.5% by weight of the CNTs described above was measured. In addition, viscosity was measured using only epoxy resin as a Comparative Example. The viscosity was measured at 20° C. in a φ 40 mm parallel cone (500 μm) using a TA instrument, Inc. Discovery. FIG. 8A shows the viscosity measurement results of the paste type composition. In the present example, by dispersing 0.1% by weight or more of CNTs, viscosity at a low shear rate of 0.1 s⁻¹ or less was 50 Pa·s or more and viscosity at a high shear rate of 100 s⁻¹ or more was 20 Pa·s or less. In addition, it was shown that viscosity increases with an increase in CNT content.

FIG. 8B shows a hysteresis of each paste type composition. From the results of FIG. 8B, it was clear that the paste type composition according to the present example had CNTs uniformly dispersed in the thermosetting resin. In addition, it was clear that the CNTs can be uniformly dispersed even if CNT content increased.

(CNT Content and Variation with Time of Viscosity of Paste Type Composition)

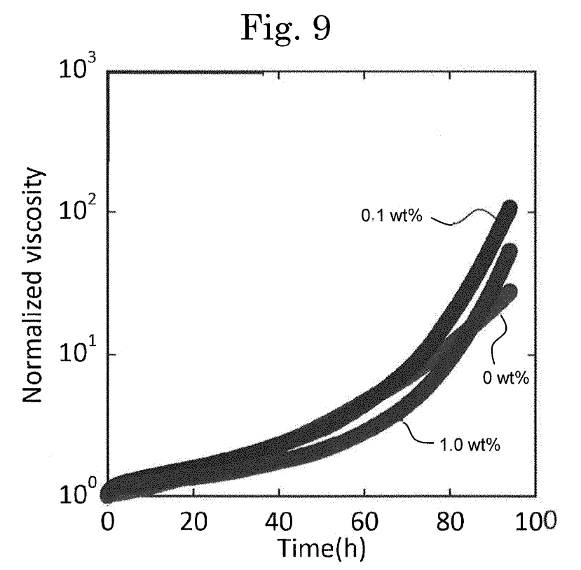

By the method described above, 0.1% by weight and 1.0% by weight of CNTs were added, and dispersed in an epoxy resin to prepare a paste type composition. Using these paste type compositions as the Example and using only epoxy resin as a Comparative Example, variation with time in the viscosity of the paste type composition and the CNT content was examined. The viscosity was measured at 20° C. in a φ 40 mm parallel cone (500 μm) using a TA instrument, Inc. Discovery. FIG. 9 is a diagram showing a CNT content and variation with time of viscosity of the paste type composition. Although the viscosity of the paste type composition over time increased in both the Example and Comparative Example, no particular dependence was observed of a variation with time of viscosity of the paste type composition with respect to the CNT content.

### (Shape Retaining Property of Paste Type Composition)

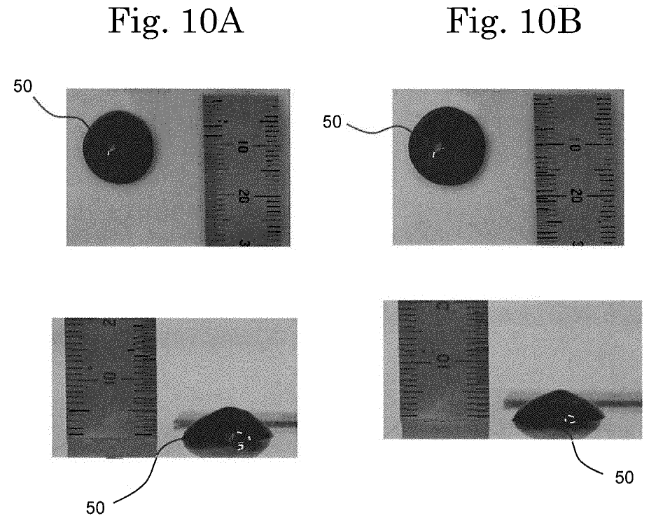

The shape retaining properties of the paste type composition 50 containing 0.1% by weight of CNTs was verified. Height was measured 1 minute after the paste composition was placed on a polyethylene terephthalate (PET) substrate. FIG. 10A is a diagram showing a paste composition immediately after being placed on a PET substrate, and FIG. 10B is a diagram showing a paste type composition 1 minute after being placed on a PET substrate. When the height immediately after placing the paste composition 50 on the substrate is T₀, and the height of the paste type composition after 1 minute is T₁, the ratio T₁/T₀ of T₁ with respect to T₀ was 0.95 which showed a good shape retaining property.

### (Recovery Speed of Shape Retaining Property in Paste Type Composition)

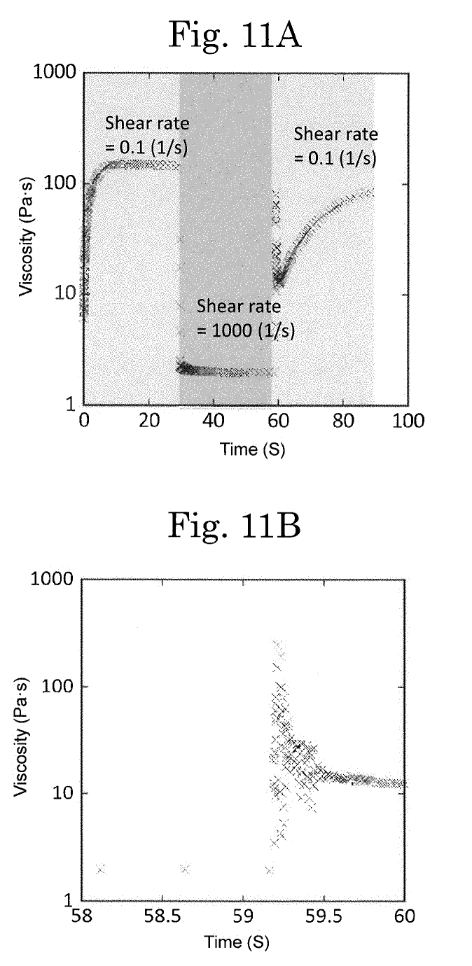

The recovery speed of the shape retaining property of the paste type composition of the Examples containing 0.1% by weight of CNTs was evaluated. A φ 40 mm parallel cone (500 μm) was used for the measurement using a TA instrument Co. Discovery. FIG. 11A shows the results of a viscosity measurement of the paste type composition of the Example, FIG. 11B shows an enlarged view of the region enclosed by the circle in FIG. 11A. The paste type composition in the Example had a viscosity measured when changing the shear rate from 1000 s⁻¹ to 0.1 s⁻¹ rose from a value of 1.92 Pa·s or less to 200 Pa·s or more within 0.1 seconds. From the results, it was shown that the shape retaining property of the paste type composition of the Example has an excellent recovery speed.

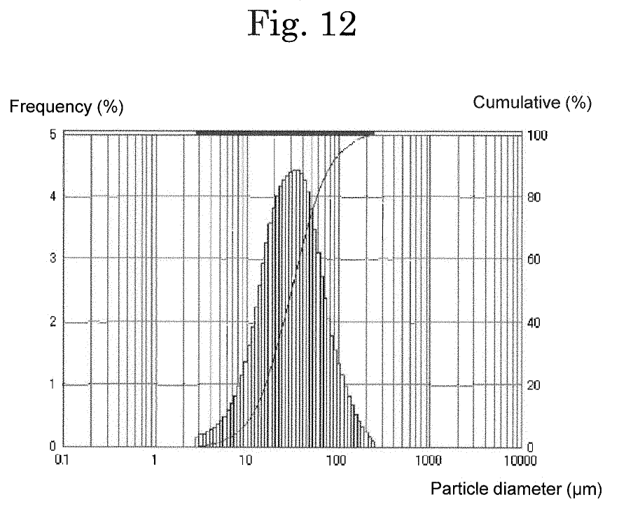

The size distribution of a CNT aggregate included in a paste type composition was evaluated using a laser diffraction method. FIG. 12 shows a size distribution of the paste type composition of the Example containing 0.1% by weight of CNTs. A median value of the particle size distribution by volume standard was 41.5 μm.

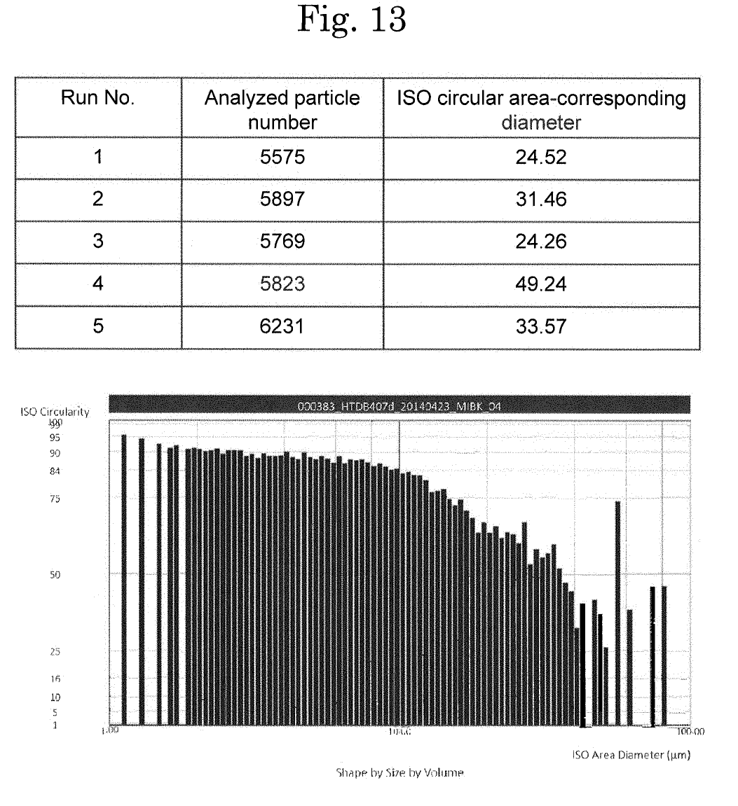

In addition, the particle size distribution of a CNT aggregate included in a paste type composition was also evaluated using an image analysis method. FIG. 13 shows the particle size distribution by volume standard of the paste type composition of the Example. The median value of the particle size distribution by volume standard was 30 μm.

The paste type composition was diluted and dripped onto a glass substrate, a CNT length in an isolated CNT aggregate was confirmed by an optical microscope and it was confirmed to have an average length of 5 μm or more.

Toray Torayca type 32525-12 (with Yarn weight per area: 125, carbon fiber content ratio: 67 Wf %, thickness: 0.12 mm, using carbon fiber T7005C) was used as the first carbon fiber dispersion layer 110. In addition, as the paste type composition 50 of the present example, a composition containing 0.1% by weight, 0.2% by weight or 0.5% by weight of CNTs was used to produce a carbon fiber composite material. In addition, the carbon fiber composite material was produced using only the epoxy resin described above without adding CNTs as a Comparative Example. The paste type composition was coated to a thickness of 30 μm using a doctor blade onto the first carbon fiber dispersion layer 110, dried for 6 hours at 50° C., and the CNT dispersion layer 130 was formed by removing the solvent within the paste type composition. An intermediate product of a carbon fiber composite material was obtained. The intermediate product and the first carbon fiber dispersion layer 110 was stacked so that the first carbon fiber dispersion layer 110 became 8 layers (ply) and the CNT dispersion layer 130 become 7 layers, the thermosetting resin was solidified by heating for 3 hours at 175° C. at 0.3 MPa within an autoclave (Hanyuda Iron Works, Dandelion) to obtain a carbon fiber composite material 100.

### (Interlayer Peeling Strength of Carbon Fiber Composite Material)

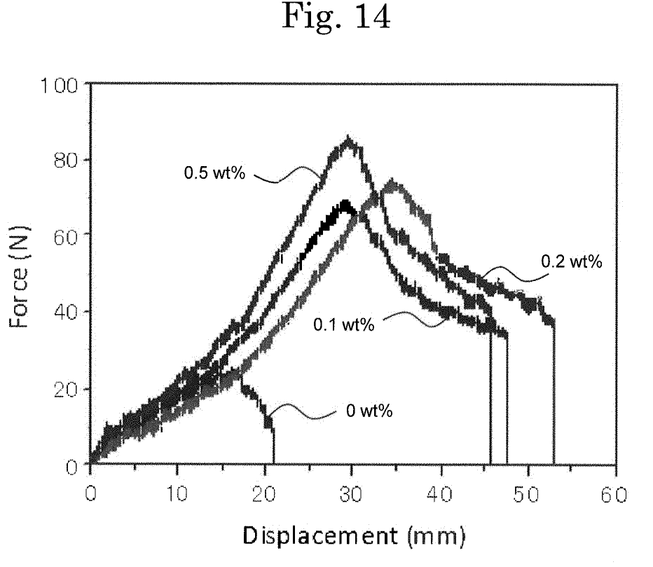

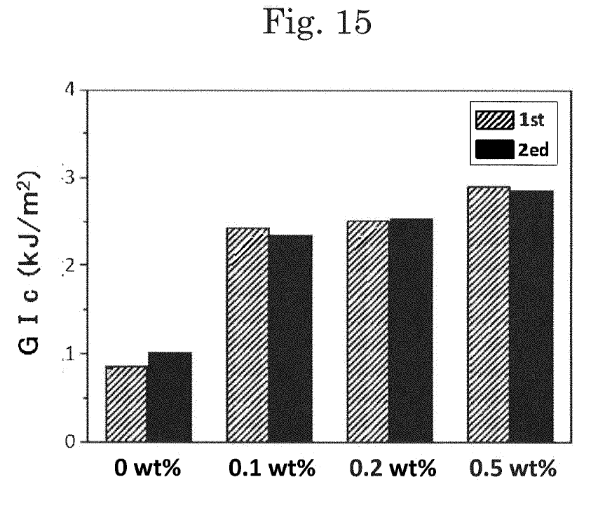

The interlayer peeling strength of the obtained carbon fiber composite material 100 (G1c) was examined. Interlayer peeling strength of the carbon fiber composite material was measured by a DCB (Double Cantilever Beam) method, mode I (open type). The measurement results of the interlayer peeling strength of the carbon fiber composite material using the paste type composition with a CNT content of 0% by weight, 0.1% by weight, 0.2% by weight and 0.5% by weight are shown in FIG. 14 and FIG. 15. While interlayer peeling strength of the carbon fiber composite material forming a CNT dispersion layer with the paste type composition having a CNT content of 0% by weight of the Comparative Example was about 20 N, it was clear that a high interlayer peeling strength of 60 N was shown by containing 0.1% by weight or more of CNTs into the paste type composition.

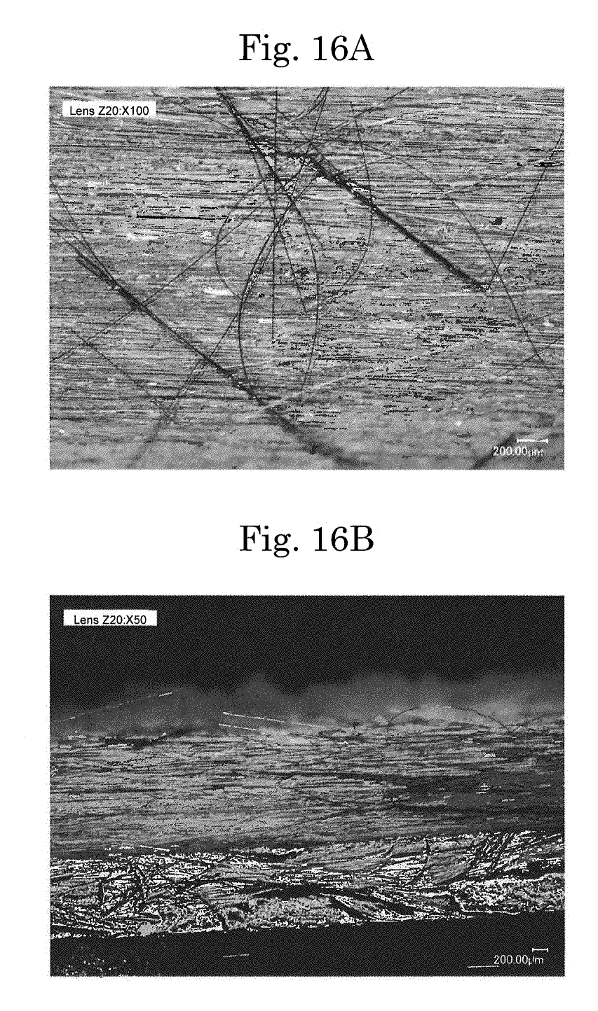

A fractured surface of the carbon fiber composite material 100 after a peeling test was observed. FIGS. 16A and 16B are optical microscope images of a fractured surface of the carbon fiber composite material 100. FIG. 16A is a top view of a fractured surface of a carbon fiber composite material 100, FIG. 16B is a cross-sectional view of a fractured surface of a carbon fiber composite material 100. In FIG. 16A and FIG. 16B, exposed carbon fibers are observed on the fractured surface. From this result, it was clear that fracture of the carbon fiber composite material 100 by the peeling test occurs not in the CNT dispersion layer 130 but in the first carbon fiber dispersion layer 110.

In addition, peaks at 532 nm and 633 nm are observed when measuring the Raman spectra of CNTs. On the other hand, peaks at 532 nm and 633 nm are not observed in the carbon fibers. Using this fact, the fractured surface of the carbon fiber composite material 100 was verified by a Raman spectrum. When the Raman spectrum of nine places in the fractured surface of the carbon fiber composite material 100 was measured, peaks at 532 nm and 633 nm were not observed. From his result, it was verified that fracture of the carbon fiber composite material 100 did not occur in the CNT dispersion layer 130.

### (Conductivity of Carbon Fiber Composite Material)

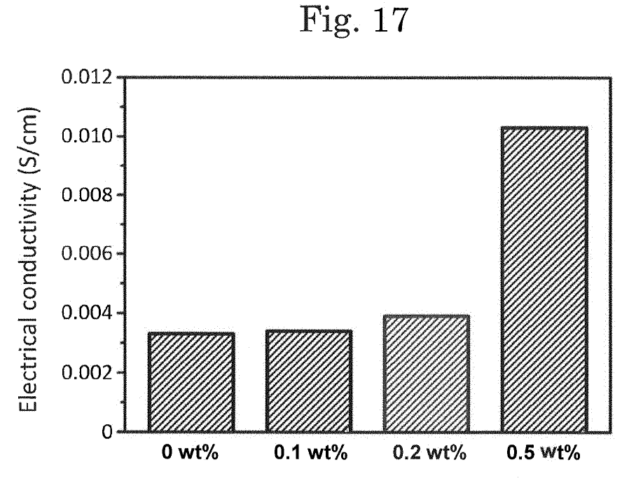

Conductivity of the carbon fiber composite materials of the Examples and Comparative Examples described above were evaluated. A conductive paste (Fujikura Kasei Co., Dotite (registered trademark) D-550) was applied to the end surface and the upper and lower surfaces (both surfaces in the stacking direction of the fiber reinforced composite material) of a fiber reinforced composite material. A R6581 digital multimeter made by Advantest Co. was connected to the conductive paste on the end surface and the upper and lower surfaces of the fiber reinforced composite material and conductivity of the sample was measured by the two-terminal method. Conductivity in the fiber axis direction measured between an end surface to end surface, and conductivity in a vertical direction with respect to the fiber axis direction measured at the upper and lower surface were respectively obtained. The conductivity of each carbon fiber composite material is shown in FIG. 17. It was clear that conductivity of the carbon fiber composite material improves according to the CNT content added to the paste type composition.

Next, the relationship between the characteristics of a CNT and the characteristics of a paste type composition was examined. A CNT produced by the method described in International Patent Publication WO2006/011655 used in the Examples described above is a single-walled CNT having an average length of 1 μm or more (hereinafter, also referred to as SGCNT). For comparison with the SGCNT, Nanocyl (Nanocyl) which is a commercially available multi-walled CNT and CoMoCAT (SouthWest NanoTechnologies) which is a single-walled CNT with an average length of less than 1 μm were used.

### (Relationship Between CNT Characteristics and Elastic Modulus of Paste Type Composition)

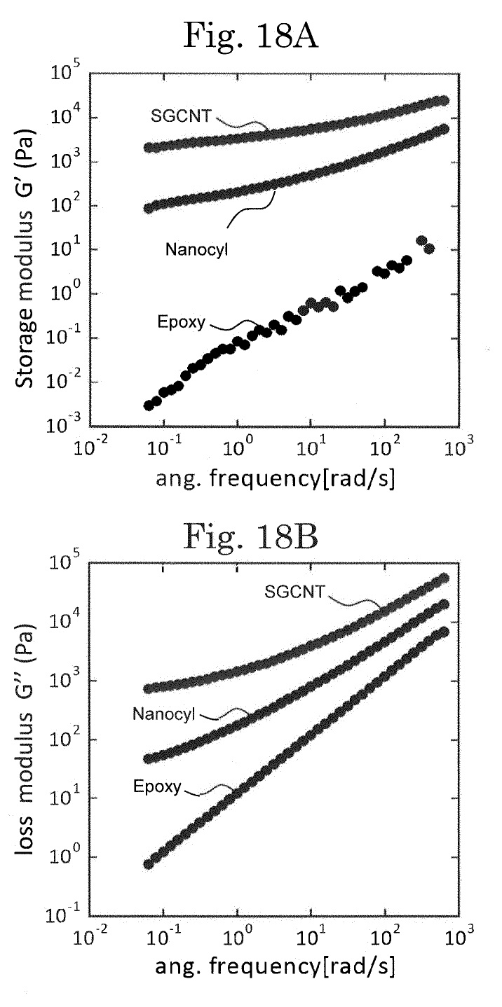

A paste type composition of the Example containing 1% by weight of CNTs was produced by the producing method described above. SGCNT and Nanocyl were used as a CNT. In addition, storage modulus and loss modulus were measured using only an epoxy resin as a Comparative Example. FIG. 18A shows the storage modulus of the paste type composition and FIG. 18B shows the loss modulus of the paste type composition. The storage modulus and the loss modulus were calculated by a dynamic viscoelasticity measurement (DMA). The dynamic viscoelasticity measurement was measured using TA instrument's twist type dynamic viscoelasticity measuring devices AR-2000ex and ARES-G2. Unless otherwise stated, the temperature of the measurement is room temperature 25° C. A circulation test was performed at an amplitude mode using a stress/strain pattern of a sine function.

From the results in FIG. 18A and FIG. 18B, the storage modulus and loss modulus of the paste type composition was shown to be significantly higher for both added CNTs in a single-walled and multi-walled. On the other hand, SGCNT had a higher storage modulus and loss modulus compared with Nanocyl, and from these results it was clear that SGCNT forms a denser network structure than Nanocyl.

### (Relationship Between CNT Characteristics and Adhesive Strength of Paste Type Composition)

A paste type composition of the Example containing 0.1% by weight of CNTs as produced using CoMoCAT by the producing method described above. In addition, a paste type composition of the Example using SGCNT and Nanocyl described above, a carbon fiber composite material using only epoxy resin was produced by the method described above as a Comparative Example, and adhesive strength of the carbon fiber composite materials was evaluated. The adhesive strength evaluations were carried out by a three-point bending test. The three-point bending was performed using an AG-IS Autograph-10 kN (Shimadzu Corporation) in compliance with JIS K7074 (5 mm/min).

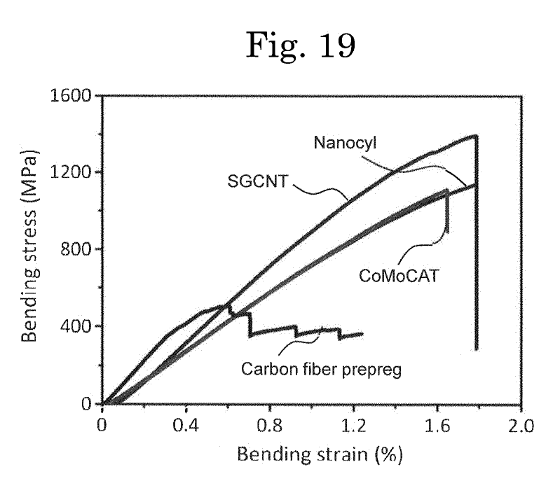

The evaluation results of the adhesive strength of the carbon fiber composite material are shown in FIG. 19. It was shown that the adhesive strength of the carbon fiber composite material is significantly higher for added CNTs in both a single-walled and multi-walled. On the other hand, it was clear that SGCNT had increased adhesive strength compared to Nanocyl and CoMoCAT.

### (Relationship Between CNT Characteristics and Conductivity of Carbon Fiber Composite Material)

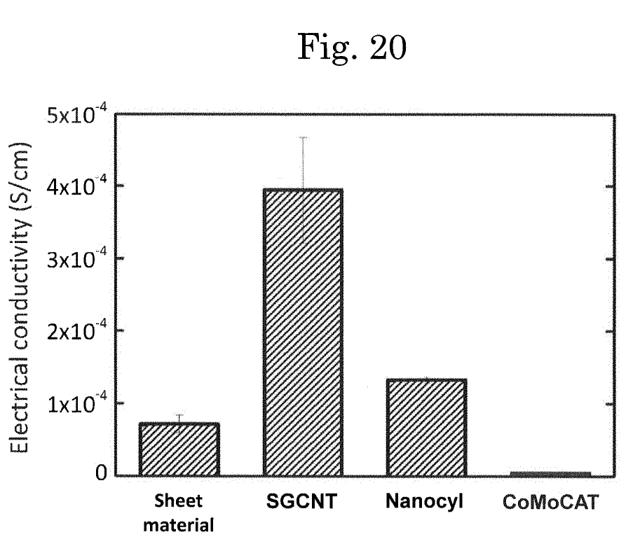

Conductivity was evaluated for the carbon fiber composite material and a sheet material of the Example described above. A conductive paste (Fujikura Kasei Co., Dotite (registered trademark) D-550) was applied to the end surface and upper and lower surfaces (both sides in the stacking direction of the fiber reinforced composite material) of a fiber reinforced composite material. A R6581 digital multimeter produced by Advantest Co. was connected to conductive paste on the end surface and the upper and lower surfaces of the fiber reinforced composite material and conductivity of the samples was measured by the two-terminal method. Conductivity in the fiber axis direction measured at the end surface to end surface, and conductivity in the vertical direction measured at the upper and lower surfaces were respectively obtained. The conductivity of each carbon fiber composite material is shown in FIG. 20. In the carbon fiber composite material containing SGCNT in a CNT dispersion layer, conductivity improved to 4 times that of the single sheet material. On the other hand, in the carbon fiber composite material containing Nanocyl and CoMoCAT in the CNT dispersion layer, significant improvement in conductivity was not recognized. From this result, it is assumed that a dense network structure is formed in the CNT dispersion layer by using a SGCNT with a long fiber length, and good conductive paths to the carbon fiber composite material are formed.

Next, optimization of the producing processes of the paste type composition and carbon fiber composite material were examined. In the present example, a method of mixing a thermosetting resin after dispersing CNTs in an organic solvent in advance was examined.

### (Paste Type Composition)

The CNTs described above and acetone (Kanto Chemical, electronic industry use EL acetone, 99.8%, ionic strength: 0) or methyl isobutyl ketone (MIBK, Sigma-Aldrich Japan, ionic strength: 0) was used as an organic solvent. The CNTs and the acetone were stirred overnight with a magnetic stir bar stirrer. The CNTs were dispersed in acetone at 60 MPa×1 pass using a jet mill (Jokoh Corp., Nano jet Pal (registered trademark) JN10). The dispersion liquid was concentrated to its limit. The dispersion liquid and an epoxy resin (Epikote 806, Mitsubishi Chemical) were mixed with a stirrer to prepare a paste type composition of the Example with a CNT content of 0.5% by weight. A solvent was evaporated on a hot stirrer and a curing agent (W, Mitsubishi Chemical) was added. In order to confirm the dispersion state of the CNTs, polyimide tape was attached to both ends of an upper surface of a slide glass, and a paste type composition of the Example obtained was stretched and coated on a central part of the slide glass by a glass rod so that a thickness became 70 μm. Heating and curing were performed by autoclave for 2 hours at 100° C.

In addition, CNT and MIBK were stirred overnight with a magnetic stir bar stirrer. CNTs were dispersed in MIBK using a jet mill (SUGINO jet mill) at 100 MPa×1 pass and 120 MPa×1 pass. The dispersion liquid was concentrated to its limit. The dispersion liquid and an epoxy resin (Epikote 806, Mitsubishi Chemical) were mixed with a stirrer to prepare a paste type composition of the Example with a CNT content of 0.5% by weight. A solvent was evaporated in a vacuum oven and a curing agent (W, Mitsubishi Chemical) was added. In order to confirm the dispersion state of the CNTs, polyimide tape was attached to both ends of an upper surface of a slide glass, and a paste type composition of the Example obtained was stretched and coated on a central part of the slide glass by a glass rod so that a thickness became 70 μm. Heating and curing were performed by autoclave for 4 hours at 175° C.

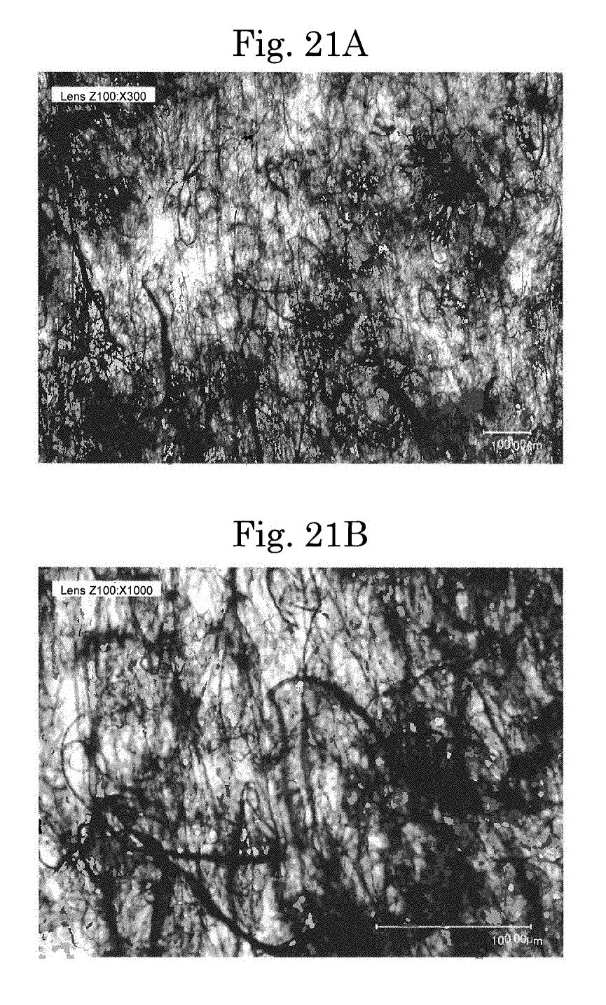

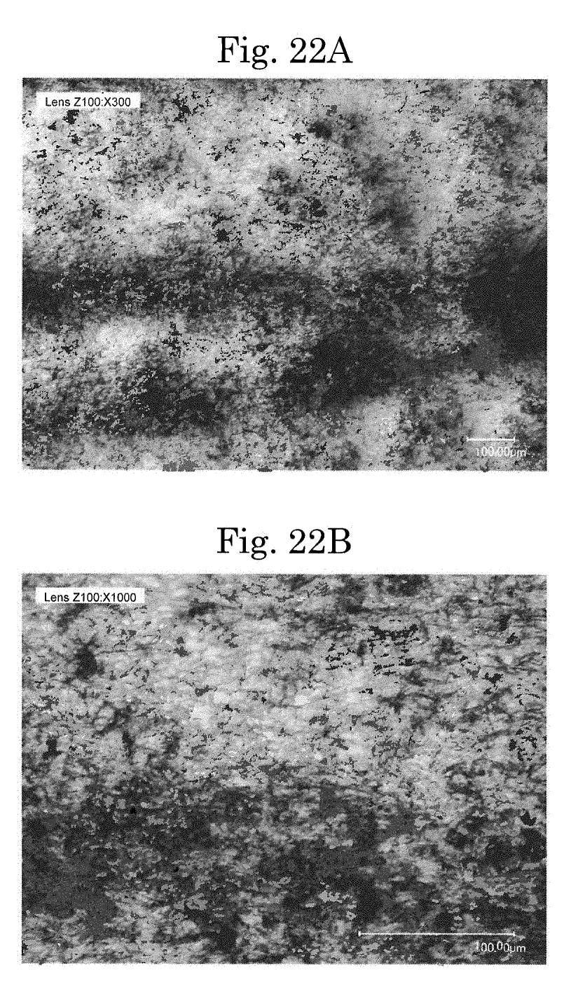

The paste type composition was observed using an optical microscope (digital microscope VHX-1000, KEYENCE). FIGS. 21A and 21B show optical microscope images of the paste type composition of the Example mixed with the epoxy resin after dispersing CNTs in acetone, FIG. 21A is at a magnification of 300, FIG. 21B is at a magnification of 1000. FIGS. 22A and 22B show optical microscope images of the paste type composition of the Example mixed with the epoxy resin after dispersing CNTs in MIBK, FIG. 22A is at a magnification of 300, FIG. 22B is at a magnification of 1000. When compared with optical microscope image of the paste type composition obtained by dispersing the previously mentioned CNTs directly in the epoxy resin (FIGS. 7A and 7B), in the present example in which CNTs are dispersed in advance in an organic solvent, the bundle of CNTs unraveled and a network structure was developed. In addition, in the case of dispersing CNTs in MIBK, it was clear that dispersibility of CNTs in the epoxy resin improved than when dispersed in acetone.

### (Viscosity Measurement of Paste Type Composition)

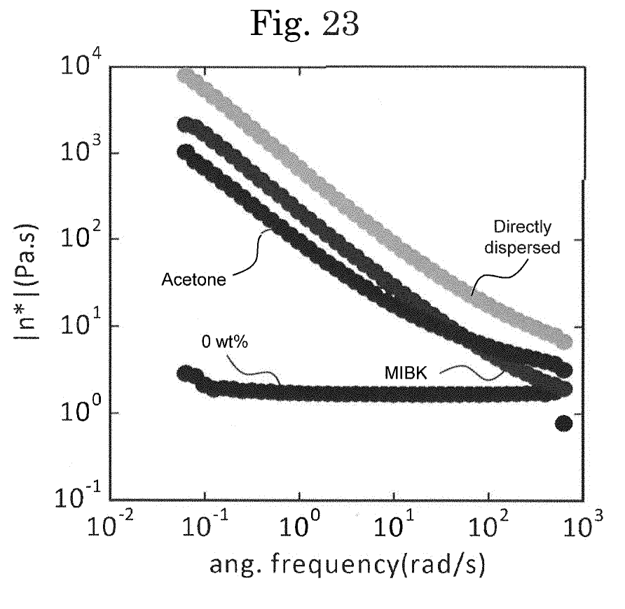

A paste type composition obtained by dispersing the aforementioned CNTs directly into an epoxy resin, a paste type composition obtained by mixing with the epoxy resin after dispersing CNTs in acetone, and a paste type composition obtained by mixing with the epoxy resin after dispersing CNTs in MIBK were used as Examples, and viscosity was measured using only epoxy resin as a Comparative Example. Viscosity was measured using a TA instrument, Inc. Discovery, at 20° C. in a φ 40 mm parallel cone (500 μm). The results of the viscosity measurement of the paste type composition are shown in FIG. 23. In the present example, viscosity at a low shear rate of 0.1 s⁻¹ or less was 50 Pa·s or more and viscosity at a high shear rate of 100 s⁻¹ or more was 20 Pa·s. On the other hand, in the example in which CNTs are dispersed in advance in an organic solvent, it was clear that viscosity decreased lower than the example in which CNTs were directly dispersed in the epoxy resin. It is presumed that organic solvent remaining in the paste type composition has an effect.

Toray Torayca type 32525-12 (with Yarn weight per area: 125, carbon fiber content: 67 Wf %, thickness: 0.12 mm, using carbon fiber T7005C) was used as the first carbon fiber dispersion layer 110. In addition, a paste type composition obtained by dispersing the aforementioned CNTs directly into an epoxy resin, a paste type composition obtained by mixing with the epoxy resin after dispersing CNTs in acetone, and a paste type composition obtained by mixing with the epoxy resin after dispersing CNTs in MIBK were used as Examples, and a carbon fiber composite material was produced using only epoxy resin as a Comparative Example. The paste type composition was coated on the first carbon fiber dispersion layer 110 by a doctor blade to a thickness of 30 um, dried for 6 hours at 50° C., a solvent within the paste composition was removed and a CNT dispersion layer 130 was formed. An intermediate product of a carbon fiber composite material was obtained. The intermediate product and the first carbon fiber dispersion layer 110 were stacked so that the first carbon fiber dispersion layer 110 was 8 layers (ply) and the CNT dispersion layer 130 was 7 layers, the thermosetting resin was solidified by heating at 175° C. for 3 hours at 0.3 MPa in an autoclave (Hanyuda Iron Works, Dandelion) and the carbon fiber composite material 100 was obtained.

### (Interlayer Peeling Strength of Carbon Fiber Composite Material)

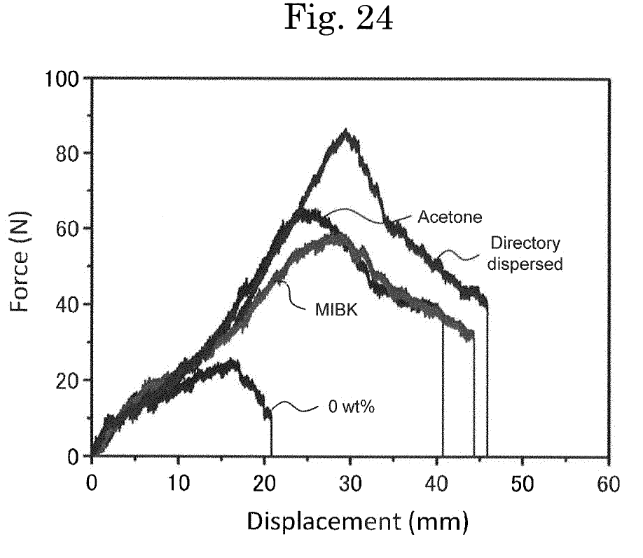

Interlayer peeling strength of the obtained carbon fiber composite material 100 was examined. Interlayer peeling strength of the carbon fiber composite material was measured by the DCB method mode I. The measurement results of the interlayer peeling strength of carbon fiber composite materials are shown in FIG. 24. While interlayer peeling strength of the carbon fiber composite material forming a CNT dispersion layer with only the epoxy resin of the Comparative Example was about 20 N, it was clear that the interlayer peeling strength increased to 60 N or more by containing 0.5% by weight of a CNT paste composition and high peeling strength was shown. On the other hand, in the Examples in which CNTs were dispersed in advance in an organic solvent CNT, it was clear that interlayer peeling strength was lower than the Example in which CNTs were directly dispersed in the epoxy resin. It is presumed that the organic solvent remaining in the paste type composition has an effect.

### (Conductivity of Carbon Fiber Composite Material)

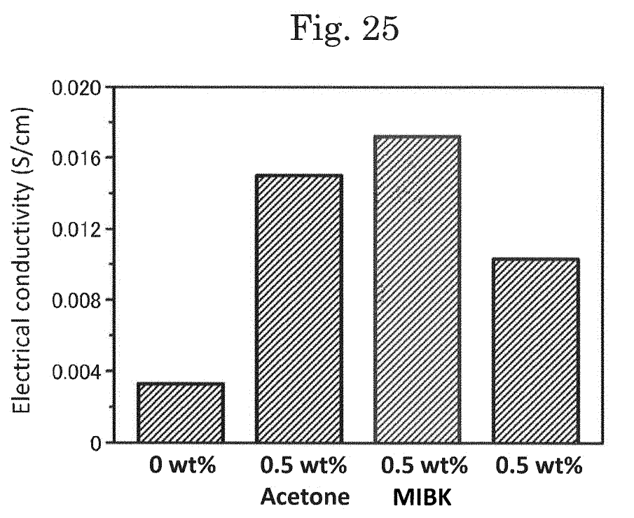

Conductivity of the carbon fiber composite materials of the Examples and Comparative Examples described above was evaluated. A conductive paste (Fujikura Kasei Co., Dotite (registered trademark) D-550) was coated on both surfaces in the stacking direction of a fiber reinforced composite material. A R6581 digital multimeter made by Advantest Co. was connected to the conductive paste on both surfaces of the fiber reinforced composite material and conductivity was calculated in the stacking direction by a four-terminal method. The conductivity of each carbon fiber composite material is shown in FIG. 25. It was clear that by containing 0.5% by weight of CNTs in a paste type composition, conductivity of the carbon fiber composite material is significantly improved. On the other hand, it was clear that in the Example in which CNTs were dispersed in advance in an organic solvent, conductivity improved more than the Example in which CNTs were directly dispersed in the epoxy resin. It is presumed that CNTs are more dispersed in the paste type composition.

Next, a dispersion method of CNTs into a thermosetting resin was examined. CNTs dried at 200° C. were mixed with a thermosetting resin in a beaker. The above described CNT resin was treated at a dispersion pressure of 60 MPa by a jet mill modified so as to have a high viscosity liquid feed (Jokoh, JN-10). After that, a resin including the CNTs described above was treated intermittently for 24 hours while changing the irradiation position using an ultrasonic homogenizer VCX180 (Vidra-Cell, Sonics, Inc.) to obtain a paste type composition.

### (Dispersion Method and Storage Modulus)

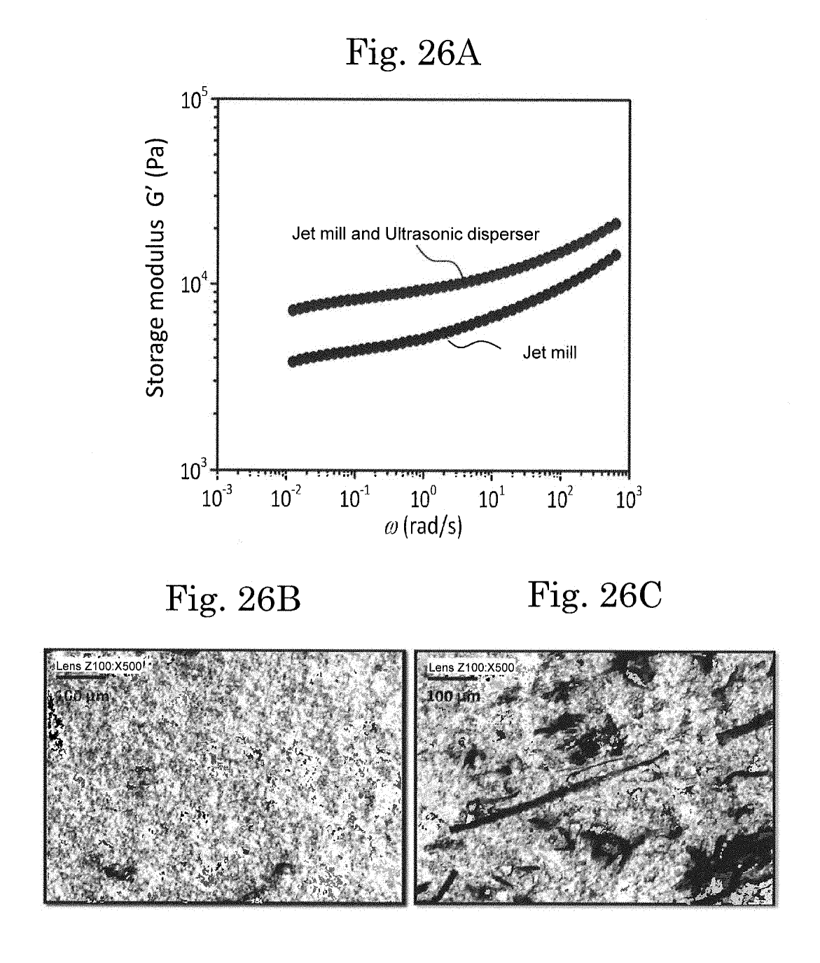

Storage modulus of a paste type composition of the Example described above in which CNTs are dispersed in an epoxy resin with a jet mill (CNT content of 0.5% by weight), and the paste type composition in which CNTs were dispersed in an epoxy resin by combining a jet mill and an ultrasonic disperser in the present example was measured. FIG. 26A is a diagram showing the storage modulus of the paste type composition. Storage modulus was improved by dispersing CNTs in an epoxy resin by combining a jet mill and an ultrasonic disperser.

Each paste composition was observed under an optical microscope. FIG. 26B is an optical microscope image of paste type composition obtained by dispersing CNTs in an epoxy resin by combining a jet mill and an ultrasonic disperser at a magnification of 100, FIG. 26C is an optical microscope image of the paste type composition obtained by dispersing CNTs in an epoxy resin with a jet mill. In FIG. 26B, it was clear that CNTs are more uniformly dispersed in the epoxy resin.

### (Dispersion Method and Adhesive Strength)

A carbon fiber composite material of the present example was produced by the producing method described above using the paste type composition described above containing 0.5% by weight of CNTs. Adhesive strength of the carbon fiber composite material of the present example was evaluated by a 3-point bending test. The 3-point bending test was performed using AG-IS Autograph −10 kN (Shimadzu Corporation) in compliance with JIS K7074 (5 mm/min).

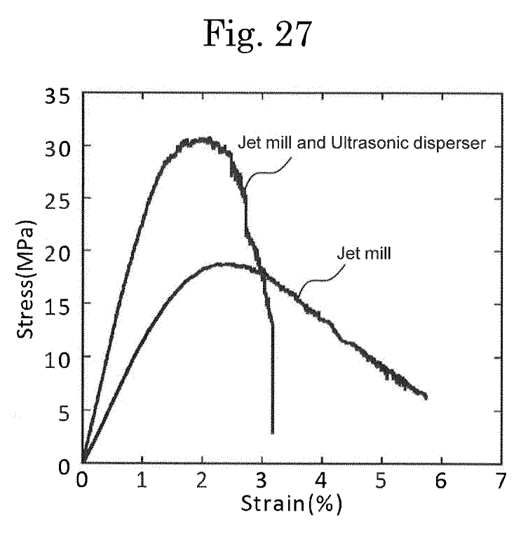

The evaluation results of adhesive strength of the carbon fiber composite material are shown in FIG. 27. It was clear that adhesive strength was improved by dispersing CNTs in an epoxy resin by combining a jet mill and ultrasonic disperser.

### (Dispersion Method and Conductivity)

Conductivity of the carbon fiber composite material of the example described above was evaluated. Furthermore, a paste type composition was produced by dispersing using only an ultrasonic disperser, and a carbon fiber composite material of the present example was produced by the producing method described above. The CNT contents of the paste type composition were 0.1%, 0.5% and 1.0% by weight. First, CNTs dried at 200° C. were mixed with a thermosetting resin in a beaker. The above described CNT resin was treated at a dispersion pressure of 60 MPa by a jet mill modified so as to have a high viscosity liquid feed (Jokoh, JN-10). After that, a resin including the CNTs described above was treated intermittently for 24 hours while changing the irradiation position using an ultrasonic homogenizer VCX180 (Vidra-Cell, Sonics, Inc.) to obtain a paste type composition.

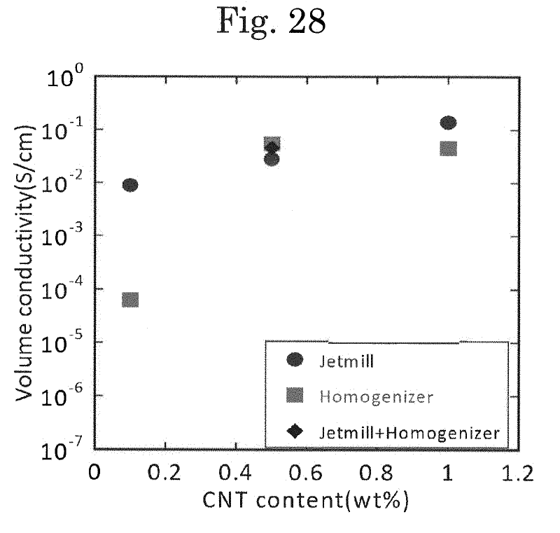

A conductive paste (Fujikura Kasei Co., Dotite (registered trademark) D-550) was applied to the end surface and upper and lower surfaces (both surfaces in the stacking direction of the fiber reinforced composite material) of a fiber reinforced composite material. A R6581 digital multimeter made by Advantest Co. was connected to the conductive paste of the end surface and the upper and lower surfaces of the fiber reinforced composite material and conductivity of the sample was measured by the two-terminal method. Conductivity in the fiber axis direction at the end surface to end surface, and conductivity in the vertical direction at the upper and lower surfaces were respectively obtained. The conductivity of each carbon fiber composite material is shown in FIG. 28.

### (Observation of Carbon Fiber Composite Material)

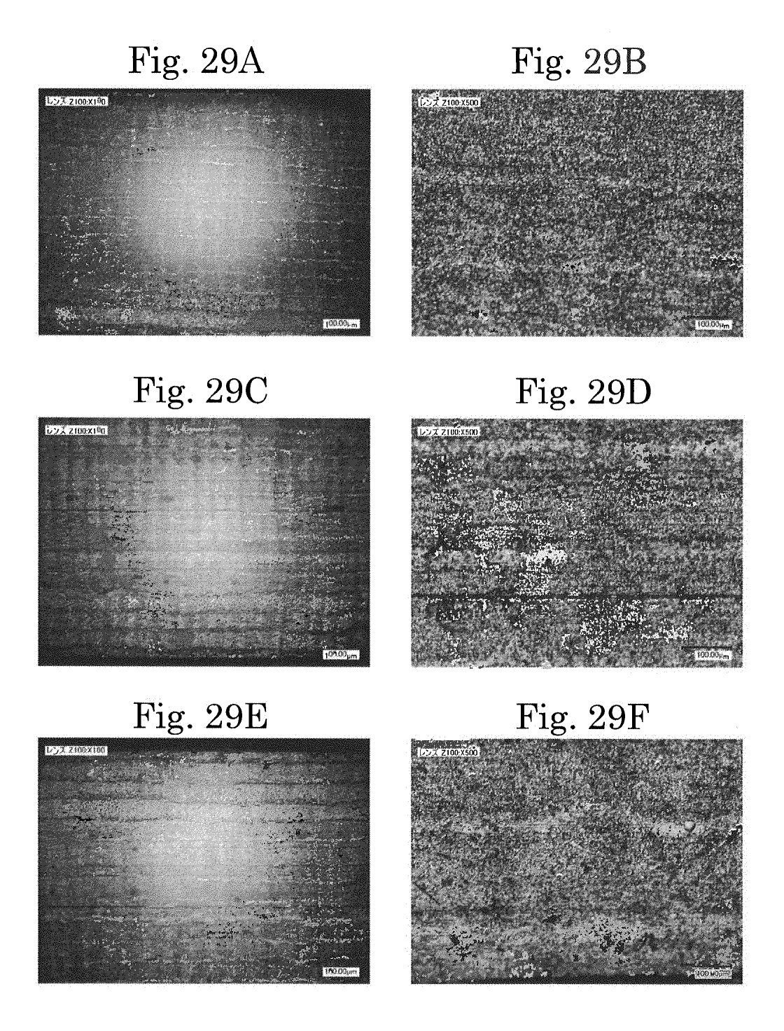

Optical microscope images of a cross section of the carbon fiber composite materials according to one example of the present invention are shown in FIGS. 29A to 29E. FIG. 29A and FIG. 29B show a reference example in which a paste type composition is not coated between carbon fiber dispersion layers. FIGS. 29C and 29D show a comparative example in which only epoxy resin is coated between carbon fiber dispersion layers. FIGS. 29E and 29F show a carbon fiber composite material of an Example of the present invention. Since protrusion or missing carbon nanotubes from the cross section of each sample could not be confirmed, and an aggregate of CNTs could not be observed, the CNTs are presumed to be uniformly dispersed in an epoxy layer.

### (Transmission Electron Microscope Image)

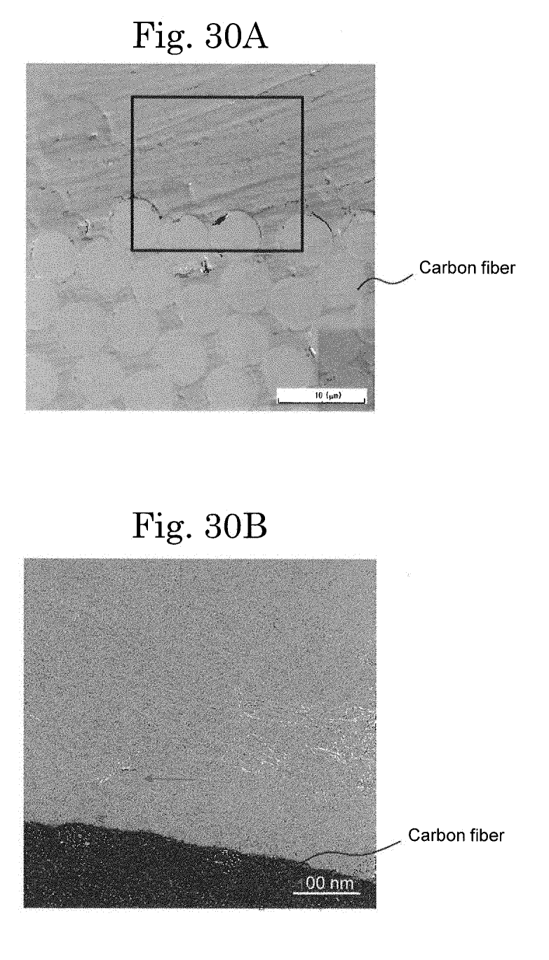

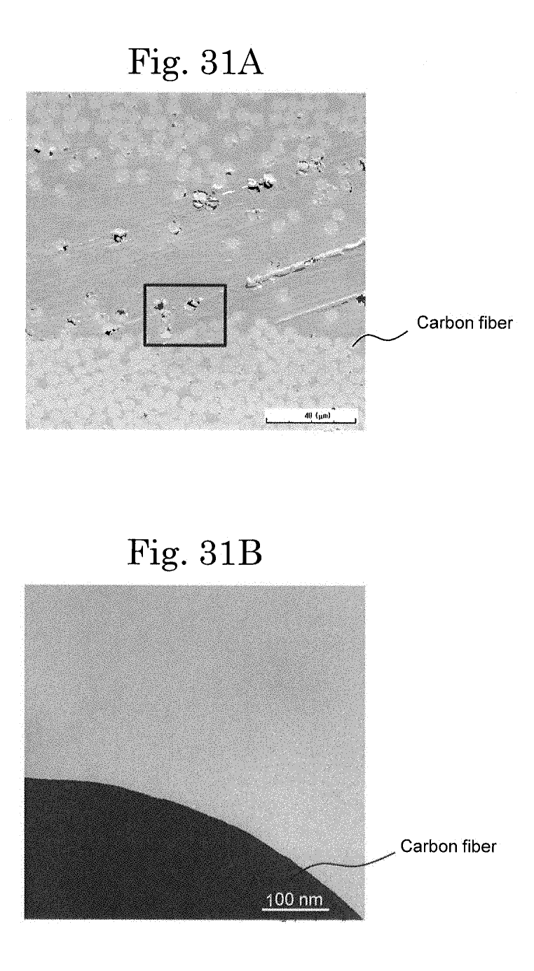

Cross-sections of the carbon fiber composite materials of the Examples and Comparative Examples described above were observed with a transmission electron microscope (TEM). Cross-sections of the carbon fiber composite material according to one example of the present invention are shown in FIGS. 30A and 30B, and Cross-sections of the carbon fiber composite material of a Comparative Example is shown in FIGS. 31A and 31B. In each diagram, a region enclosed by a frame in FIG. 30A or 31A is enlarged and shown in FIG. 30B or 31B. The arrow in FIG. 30B indicates a CNT. In the carbon fiber composite materials of the Example, it was clear that CNTs in a CNT dispersion layer are arranged in close contact with the carbon fibers in a carbon fiber dispersed layer.

### (Raman Spectrum)

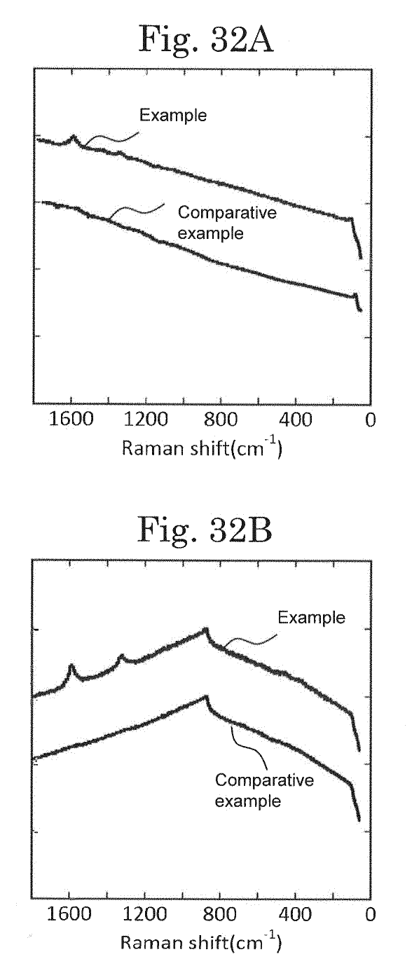

In order to verify the observation results by a TEM, Raman spectrums of a cross-section of a carbon fiber composite material of the Examples and Comparative Examples were measured. The Raman spectrums are shown in FIGS. 32A and 32B. FIG. 32A shows the measurement results at 532 nm, and FIG. 32B shows the measurement results at 633 nm. The cross-section of the carbon fiber composite material of the Examples was observed to have a maximum peak intensity in the range 1560 cm⁻¹ or more and 1600 cm⁻¹ or less which is called the G band derived from graphite.

According to the present invention, it is possible to provide a carbon fiber composite material and a producing method thereof including an adhesive layer having high peeling strength and excellent conductivity. The carbon fiber composite material of the present invention has a high peeling strength via an adhesive layer and also is an excellent material having high conductivity.

What is claimed is:

1. A carbon fiber composite material comprising:
a first carbon fiber dispersion layer having carbon fibers dispersed in a thermosetting resin;
a carbon nanotube dispersion layer having carbon nanotubes dispersed in a thermosetting resin; and
a second carbon fiber dispersion layer having carbon fibers dispersed in a thermosetting resin;
wherein
the carbon nanotube dispersion layer is arranged between the first carbon fiber dispersion layer and the second carbon fiber dispersion layer; and
the carbon nanotubes in the carbon nanotube dispersion layer are arranged in close contact with the carbon fibers of the first carbon fiber dispersion layer and the carbon fibers of the second carbon fiber dispersion layer.

2. A carbon fiber composite material comprising:
a first carbon fiber dispersion layer having carbon fibers dispersed in a thermosetting resin;
a carbon nanotube dispersion layer having carbon nanotubes dispersed in a thermosetting resin; and
a second carbon fiber dispersion layer having carbon fibers dispersed in a thermosetting resin;
wherein
the carbon nanotube dispersion layer is arranged between the first carbon fiber dispersion layer and the second carbon fiber dispersion layer; and
the carbon fiber composite material has at least one of an interlayer peeling strength of 300 J/m² or more, conductivity in a fiber axis direction of 0.1 S/cm or more, conductivity in a vertical direction with respect to the fiber axis direction of 10⁻⁵ S/cm or more, and a three-point bending strength of 500 MPa or more.

3. The carbon fiber composite material according to claim 1, wherein the carbon nanotube dispersion layer has a film shape.

4. The carbon fiber composite material according to claim 1, wherein a size of a carbon nanotube aggregate within the carbon nanotube dispersion layer is in a range of 5 μm or more and 50 μm or less of a median value of a particle size distribution at a volume standard.

5. The carbon fiber composite material according to claim 1, wherein a carbon nanotube density of the carbon nanotube aggregate within the carbon nanotube dispersion layer is 0.1% by weight or more.

6. The carbon fiber composite material according to claim 1, wherein an average length of the carbon nanotube of the carbon nanotube aggregate within the carbon nanotube dispersion layer is 1 μm or more.

7. The carbon fiber composite material according to claim 1, wherein a thickness of the carbon nanotube dispersion layer is 0.1 μm or more.

8. A producing method of a carbon fiber composite material comprising:
forming a first carbon fiber dispersion layer by dispersing carbon fibers in a thermosetting resin;
forming a carbon nanotube dispersion layer by dispersing carbon nanotubes in a thermosetting resin; and
forming a second carbon fiber dispersion layer by dispersing carbon fibers in a thermosetting resin;
wherein
the carbon fiber composite material is formed by arranging the carbon nanotube dispersion layer between the first carbon fiber dispersion layer and the second carbon fiber dispersion layer; and
the carbon nanotubes in the carbon nanotube dispersion layer are arranged in close contact with the carbon fibers of the first carbon fiber dispersion layer and the carbon fibers of the second carbon fiber dispersion layer.

9. A producing method of a carbon fiber composite material comprising:
forming a first carbon fiber dispersion layer by dispersing carbon fibers in a thermosetting resin;
forming a carbon nanotube dispersion layer by dispersing carbon nanotubes in a thermosetting resin; and
forming a second carbon fiber dispersion layer by dispersing carbon fibers in a thermosetting resin;
wherein
the carbon fiber composite material is formed by being arranging the carbon nanotube dispersion layer between the first carbon fiber dispersion layer and the second carbon fiber dispersion layer; and
the carbon fiber composite material has at least one of an interlayer peeling strength of 300 J/m² or more, conductivity in a fiber axis direction of 0.1 S/cm or more, conductivity in a vertical direction with respect to the fiber axis direction of 10⁻⁵ S/cm or more, and a three-point bending strength of 500 MPa or more.

10. The producing method of a carbon fiber composite material according to claim 8, wherein the carbon nanotube dispersion layer has a film shape.

11. The producing method of a carbon fiber composite material according to claim 8, wherein a size of a carbon nanotube aggregate within the carbon nanotube dispersion layer is in a range of 5 μm or more and 50 μm or less of a median value of a particle size distribution at a volume standard.

12. The producing method of a carbon fiber composite material according to claim 8, wherein a carbon nanotube density of the carbon nanotube aggregate within the carbon nanotube dispersion layer is 0.1% by weight or more.

13. The producing method of a carbon fiber composite material according to claim 8, wherein an average length of the carbon nanotube of the carbon nanotube aggregate within the carbon nanotube dispersion layer is 1 μm or more.

14. The producing method of a carbon fiber composite material according to claim 8, wherein a thickness of the carbon nanotube dispersion layer is 0.1 μm or more.

15. A paste type carbon nanotube contained resin material coated on the first carbon fiber dispersion layer and/or the second carbon fiber dispersion layer of the carbon fiber composite material according to claim 1, wherein the paste type carbon nanotube contained resin material has a viscosity measured by a rheometer of 50 Pa·s or more in a stationary state and/or 20 Pa·s or less under a condition of a sheer rate of 100 s⁻¹ or more.
